(19) United States
(12) Patent Application Publication
(10) Pub. No.: US 2008/0300993 A1
(43) Pub. Date: Dec. 4, 2008

(54) COMPUTERIZED METHOD AND SYSTEM FOR RECIPE PRESENTATION

(76) Inventor: Assaf Rozenblatt, Glen Cove, NY (US)

Correspondence Address: DARBY & DARBY P.C., P.O. BOX 770, Church Street Station, New York, NY, 10008-0770, US

(21) Appl. No.: 11/756,093

(22) Filed: May 31, 2007

(51) Int. Cl. G06Q 30/00; G06F 15/16; G06F 17/30

(52) U.S. Cl. 705/23; 705/1; 705/16; 709/218

(57) ABSTRACT

A method for interactive recipe presentation including initially receiving, at a server, an indication from a user of at least one first ingredient, querying the user, by the server, whether at least one additional ingredient is available, additionally receiving from the user in response to the querying, an indication of which, if any, of the at least one additional ingredient is available and providing to the user at least one recipe, which requires the at least one first ingredient and which requires any of the at least one additional ingredient which is available and which does not require other non-staple ingredients.

### FIELD OF THE INVENTION

The present invention relates to computerized methods and systems for presenting recipes.

### BACKGROUND OF THE INVENTION

The following publications are believed to represent the current state of the art:

U.S. Pat. Nos. 5,832,446; 5,960,440; 6,049,831; 6,236,974; 6,370,513 and 6,549,818

http://www.cooks.com/

http://www.allrecipes.com/

http://www.epicurious.com/

### SUMMARY OF THE INVENTION

The present invention seeks to provide an improved computerized method and system for recipe presentation.

There is thus provided in accordance with a preferred embodiment of the present invention a method for interactive recipe presentation including initially receiving, at a server, an indication from a user of at least one first ingredient, querying the user, by the server, whether at least one additional ingredient is available, additionally receiving from the user in response to the querying, an indication of which, if any, of the at least one additional ingredient is available and providing to the user at least one recipe, which requires the at least one first ingredient and which requires any of the at least one additional ingredient which is available and which does not require other non-staple ingredients.

In accordance with a preferred embodiment of the present invention at least one of the initially receiving and the additionally receiving employs communication via a computer network. Alternatively, at least one of the initially receiving and the additionally receiving employs communication via a cellular telephone network. Preferably, at least one of the initially receiving and the additionally receiving employs voice communication.

In accordance with another preferred embodiment of the present invention the querying includes obtaining at least one recipe which requires the at least one first ingredient, finding in the at least one recipe at least one other ingredient not included in the at least one first ingredient and querying the user whether the at least one other ingredient is available as the at least one additional ingredient.

There is also provided in accordance with another preferred embodiment of the present invention a method for interactive recipe presentation including receiving, at a server, an indication from a user of at least one first ingredient, automatically searching a database linked to the server to find recipes which require the at least one first ingredient, ordering the recipes so as to give a first, higher, precedence to ones of the recipes which do not require non-staple ingredients other than the at least one first ingredient and to give successively lower precedence to ones of the recipes additionally requiring successively greater numbers of non-staple ingredients other than the at least one first ingredient and presenting the recipes to the user in accordance with the ordering.

In accordance with a preferred embodiment of the present invention the receiving employs communication via a computer network. Alternatively, the receiving employs communication via a cellular telephone network. Preferably, the receiving employs voice communication.

In accordance with another preferred embodiment of the present invention the receiving includes initially receiving, at the server, an indication from the user of the at least one first ingredient, querying the user, by the server, whether at least one additional ingredient is available and receiving from the user in response to the querying, an indication of which, if any, of the at least one additional ingredient is available. Preferably, the querying includes obtaining at least one recipe which requires the at least one first ingredient, finding in the at least one recipe at least one other ingredient not included in the at least one first ingredient and querying the user whether the at least one other ingredient is available as the at least one additional ingredient.

There is further provided in accordance with a further preferred embodiment of the present invention a method for interactive recipe presentation including receiving at a server, from a user, a list of ingredients available to a user and providing to the user at least one recipe which requires at least one ingredient included in the list of ingredients and which does not require non-staple ingredients not included in the list of ingredients.

In accordance with a preferred embodiment of the present invention the method also includes, prior to the providing, receiving at the server, an indication from the user of at least one first ingredient included in the list of ingredients and wherein the at least one recipe requires the at least one first ingredient. Preferably, the receiving employs communication via a computer network. Additionally or alternatively, the receiving employs communication via a cellular telephone network. Preferably, the receiving employs voice communication.

In accordance with another preferred embodiment of the present invention the method also includes updating the list of ingredients to take into account at least one of additional available ingredients and ingredients no longer available.

In accordance with yet another preferred embodiment of the present invention the receiving includes automated reading of ingredient labels. Preferably, the automated reading takes place at user premises. Additionally or alternatively, the automated reading takes place at a point of sale of the ingredients.

In accordance with still another preferred embodiment of the present invention the automated reading includes reading information indicating expiration dates of ones of the ingredients. Preferably, the method also includes updating the list of ingredients to take into account at least one of additional available ingredients and ingredients no longer available based on the automated reading.

There is additionally provided in accordance with an additional preferred embodiment of the present invention a method for interactive recipe presentation including receiving, at a server, from a user a list of ingredients available to the user, automatically searching a database linked to the server to find recipes which require at least one ingredient included in the list of ingredients, ordering the recipes so as to give first, higher, precedence to ones of the recipes which do not require non-staple ingredients not included in the list of ingredients and to give successively lower precedence to ones of the recipes additionally requiring successively greater numbers of non-staple ingredients not included in the list of ingredients and presenting the recipes to the user in accordance with the ordering.

In accordance with a preferred embodiment of the present invention the method also includes, prior to the automatically searching, receiving at the server an indication from the user of at least one first ingredient and wherein the ordering gives higher precedence to ones of the recipes requiring the at least one first ingredient which do not require non-staple ingredients not included in the list of ingredients and successively lower precedence to ones of the recipes requiring the at least one first ingredient and additionally requiring successively greater numbers of non-staple ingredients not included in the list of ingredients. Preferably, the method also includes updating the list of ingredients to take into account at least one of additional available ingredients and ingredients no longer available.

In accordance with another preferred embodiment of the present invention the receiving employs communication via a computer network. Preferably, the receiving employs communication via a cellular telephone network. Additionally or alternatively, the receiving employs voice communication.

In accordance with yet another preferred embodiment of the present invention the receiving includes automated reading of ingredient labels. Preferably, the automated reading takes place at user premises. Additionally or alternatively, the automated reading takes place at a point of sale of the ingredients. Preferably, the automated reading includes reading information indicating expiration dates of ones of the ingredients.

In accordance with a further preferred embodiment of the present invention the method also includes updating the list of ingredients to take into account at least one of additional available ingredients and ingredients no longer available based on the automated reading. Preferably, the ordering the recipes gives higher precedence to ones of the recipes which require ones of the ingredients included in the list of ingredients whose expiration dates are imminent.

There is also provided in accordance with another preferred embodiment of the present invention a method for interactive recipe presentation including receiving, at a server, from a point of sale, a list of ingredients purchased by a user and providing to the user at least one recipe which requires at least one ingredient included in the list of ingredients.

In accordance with a preferred embodiment of the present invention the at least one recipe does not require non-staple ingredients not included in the list of ingredients. Preferably, the providing includes printing the at least one recipe on a purchase receipt at the point of sale. Additionally or alternatively, the providing includes printing the at least one recipe at the point of sale.

In accordance with another preferred embodiment of the present invention the providing includes providing the at least one recipe at user premises. Preferably, the method also includes storing the list of ingredients in a user's available ingredients database associated with the server and additionally receiving at the server an indication from the user of at least a first ingredient included in the list of ingredients and wherein the at least one recipe requires the at least first ingredient.

In accordance with yet another preferred embodiment of the present invention the receiving employs communication via a computer network. Additionally or alternatively, the receiving employs communication via a cellular telephone network. Preferably, the receiving employs voice communication.

In accordance with still another preferred embodiment of the present invention the method also includes updating the list of ingredients to take into account at least one of additional available ingredients and ingredients no longer available. Preferably, the receiving from a point of sale includes automated reading of ingredient labels. Additionally or alternatively, the automated reading includes reading information indicating expiration dates of ones of the ingredients.

In accordance with a further preferred embodiment of the present invention the method also includes updating the list of ingredients to take into account at least one of additional available ingredients and ingredients no longer available based on the automated reading. Preferably, the method also includes automatically searching a recipes database, by said server, to find recipes which require at least one ingredient included in the list of ingredients and ordering the recipes so as to give a first, higher, precedence to ones of the recipes which do not require non-staple ingredients not included in the list of ingredients and to give successively lower precedence to ones of the recipes additionally requiring successively greater numbers of non-staple ingredients not included in the list of ingredients.

In accordance with a yet further preferred embodiment of the present invention the method also includes, prior to the searching, receiving at the server an indication from the user of at least one first ingredient and wherein the ordering gives higher precedence to ones of the recipes requiring the at least one first ingredient which do not require non-staple ingredients not included in the list of ingredients and successively lower precedence to ones of the recipes requiring the at least one first ingredient and additionally requiring successively greater numbers of non-staple ingredients not included in the list of ingredients. Preferably, the method also includes updating the list of ingredients to take into account at least one of additional available ingredients and ingredients no longer available.

In accordance with a still further preferred embodiment of the present invention the receiving employs communication via a computer network. Additionally or alternatively, the receiving employs communication via a cellular telephone network. Preferably, the receiving employs voice communication.

In accordance with an additional preferred embodiment of the present invention the receiving includes automated reading of ingredient labels. Preferably, the automated reading includes reading information indicating expiration dates of ones of the ingredients. Additionally or alternatively the method also includes updating the list of ingredients to take into account at least one of additional available ingredients and ingredients no longer available based on the automated reading.

In accordance with another preferred embodiment of the present invention the ordering the recipes gives higher precedence to ones of the recipes which requires ones of the ingredients included in the list of ingredients whose expiration dates are imminent.

There is further provided in accordance with a further preferred embodiment of the present invention a method for interactive presentation of shopping suggestions including receiving, at a server, an indication from a user of at least one first ingredient, querying a recipe database for additional ingredients used together with the at least one first ingredient and providing to the user an indication of the additional ingredients.

In accordance with a preferred embodiment of the present invention the receiving includes receiving a list of ingredients available to the user. Preferably, the querying includes querying the recipe database for additional ingredients often used together with subgroups of the list of ingredients.

In accordance with another preferred embodiment of the present invention the method also includes, prior to the providing, additionally receiving at the server an indication from the user of at least one principal ingredient included in the list of ingredients and wherein the providing includes providing to the user an indication of at least one additional ingredient often used with the at least one principal ingredient. Preferably, the method also includes updating the list of ingredients to take into account at least one of additional available ingredients and ingredients no longer available. Additionally or alternatively, the receiving the list of ingredients available to the user includes automated reading of ingredient labels.

In accordance with yet another preferred embodiment of the present invention the automated reading takes place at user premises. Alternatively, the automated reading takes place at a point of sale of the ingredients. Preferably, the automated reading includes reading information indicating expiration dates of ones of the ingredients. Additionally or alternatively, the method also includes updating the list of ingredients to take into account at least one of additional available ingredients and ingredients no longer available based on the automated reading.

In accordance with a further preferred embodiment of the present invention the receiving includes receiving an indication of a desired principal ingredient. Preferably the method also includes presenting to the user at least one recipe requiring the at least one first ingredient and at least one of the additional ingredients. Additionally or alternatively, the receiving employs communication via a computer network.

In accordance with a yet further preferred embodiment of the present invention the receiving employs communication via a cellular telephone network. Preferably, the receiving employs voice communication.

### BRIEF DESCRIPTION OF THE DRAWINGS

The present invention will be understood and appreciated more fully from the following detailed description, taken in conjunction with the drawings in which:

FIG. 1 is a simplified pictorial illustration of a computerized methodology and system for recipe presentation, constructed and operative in accordance with a preferred embodiment of the present invention;

FIGS. 2A and 2B together are a simplified flow chart illustrating the operation of the methodology and system of FIG. 1;

FIGS. 3A, 3B, 3C, 3D, 3E and 3F are simplified pictorial illustrations of six alternative embodiments of a computerized methodology and system for integrated ingredients inventorying and recipe presentation constructed and operative in accordance with a preferred embodiment of the present invention;

FIGS. 4A and 4B together are a simplified flow chart illustrating the operation of the methodology and system of FIGS. 3A and 3D;

FIGS. 5A and 5B together are a simplified flow chart illustrating the operation of the methodology and system of FIGS. 3B, 3C, 3E and 3F;

FIGS. 6A and 6B are simplified pictorial illustrations of two alternative embodiments of a computerized methodology and system for integrated point of sale monitoring, ingredients inventorying and recipe presentation constructed and operative in accordance with a preferred embodiment of the present invention;

FIGS. 7A and 7B together are a simplified flow chart illustrating the operation of the methodology and system of FIG. 6A;

FIGS. 8A and 8B together are a simplified flow chart illustrating the operation of the methodology and system of FIG. 6B;

FIGS. 9A and 9B are simplified pictorial illustrations of two alternative embodiments of a computerized methodology and system for integrated point of sale monitoring, ingredients inventorying and multi-media recipe presentation constructed and operative in accordance with a preferred embodiment of the present invention;

FIG. 10 is a simplified flow chart illustrating the operation of the methodology and system of FIGS. 9A and 9B;

FIGS. 11A and 11B are simplified pictorial illustrations of two alternative embodiments of a computerized methodology and system for integrated point of sale monitoring, ingredients inventorying, ingredient expiration monitoring and multi-media recipe presentation constructed and operative in accordance with a preferred embodiment of the present invention;

FIGS. 12A and 12B together are a simplified flow chart illustrating the operation of the methodology and system of FIGS. 11A and 11B;

FIGS. 13A and 13B are simplified pictorial illustrations of two alternative embodiments of a computerized methodology and system for integrated ingredients inventorying, ingredient purchase prompting and multi-media recipe presentation constructed and operative in accordance with a preferred embodiment of the present invention; and

FIGS. 14A, 14B, 14C and 14D are together a simplified flow chart illustrating the operation of the methodology and system of FIGS. 13A and 13B.

### DETAILED DESCRIPTION OF PREFERRED EMBODIMENTS

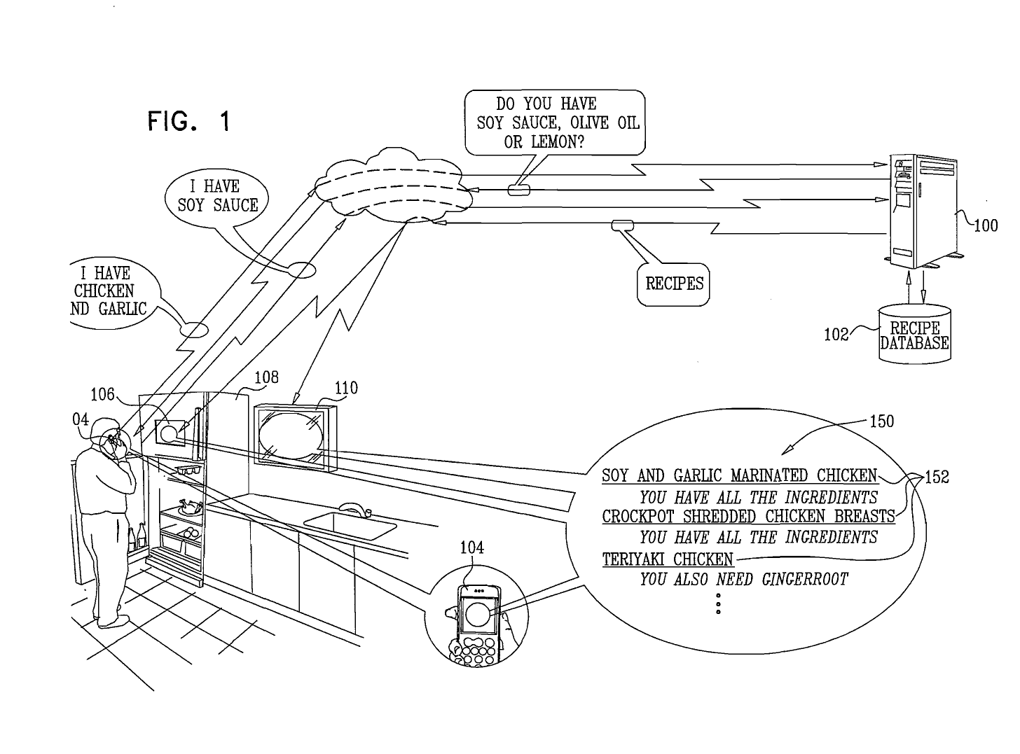

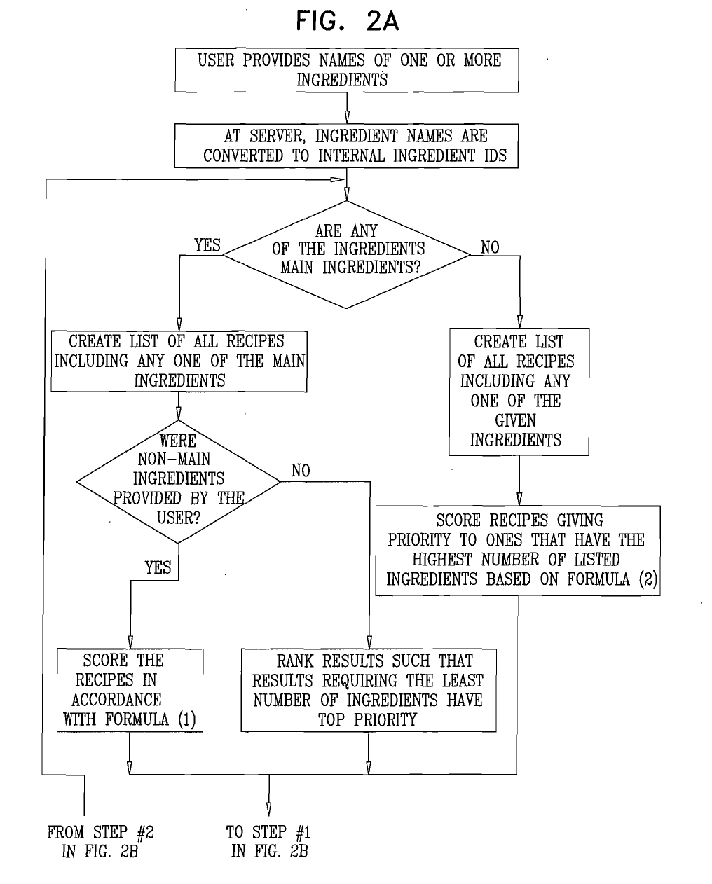

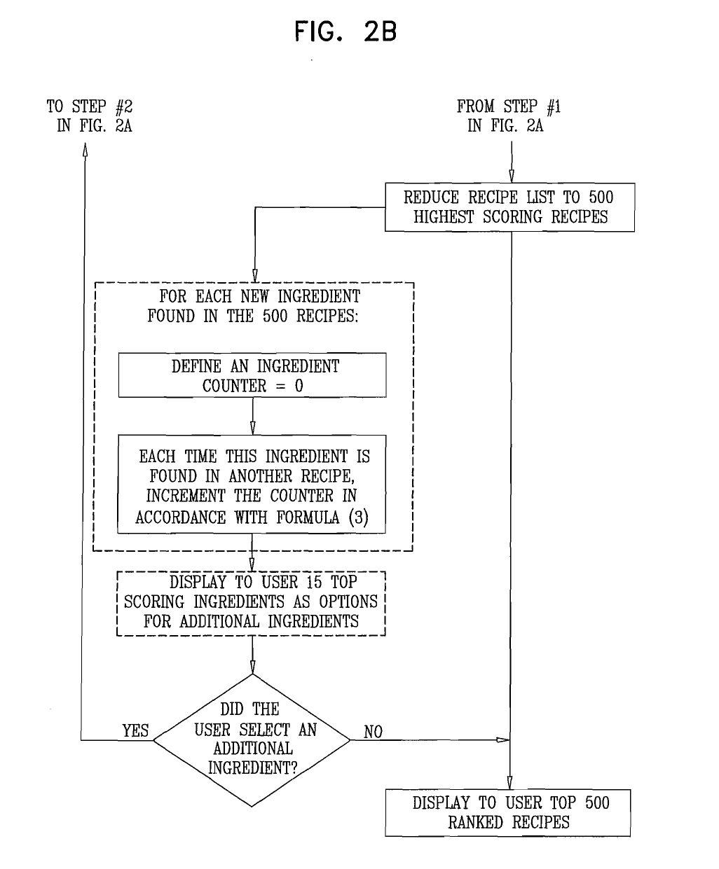

Reference is now made to FIG. 1, which is a simplified pictorial illustration of a computerized methodology and system for recipe presentation, constructed and operative in accordance with a preferred embodiment of the present invention, and to FIGS. 2A and 2B, which together are a simplified flow chart illustrating the operation of the methodology and system of FIG. 1.

As seen in FIG. 1, a user communicates via a communication network, which is typically a wireless communication network, such as the Internet, with a recipe server 100, having associated therewith a recipe database 102. User communication with the recipe server 100 may be in any suitable manner and may employ a web-enabled portable communication device, such as a Motorola Q cellular telephone 104, a computer 106 embedded into a kitchen appliance, such as a refrigerator 108, or a conventional fixed or portable computer 10.

In a typical scenario, the user inputs to the recipe server 100 the names of one or more ingredients that he has available. In the illustrated example, the user inputs an indication that he has CHICKEN and GARLIC. This input may be effected orally, as by the user stating “I HAVE CHICKEN AND GARLIC” or in written form, as via a conventional keyboard or touch screen.

The recipe server 100 is preferably operative to convert the CHICKEN and GARLIC indications to corresponding internal ingredient identification codes, such as 1010 and 3216. The recipe server 100 preferably maintains a predetermined list of “main ingredients” in a look-up table or other form. The recipe server 100 also preferably maintains a predetermined list of “staple ingredients” such as salt, pepper, water and sugar, which are assumed to be available in every kitchen. Typical main ingredients are, for example, CHICKEN, SALMON, STEAK, BEEF, TURKEY, VEAL, LAMB, PASTA, TOFU and TUNA.

If any of the identification codes corresponding to ingredient indications which are inputted by the user to the recipe server 100 relate to main ingredients, the recipe server 100 creates a list of all recipes in the recipe database 102 which include any one or more of the main ingredients which are indicated by the user. In this example, the only main ingredient indicated by the user is CHICKEN and thus, the recipe server 100 provides a list of all recipes including chicken.

Had the user only indicated CHICKEN and not also indicated a non-main ingredient, the recipe server 100 would have ranked the list of recipes including chicken by the least number of additional non-staple ingredients required. In this case, since the user also indicated GARLIC, the recipe server top ranks the recipes containing chicken which also contain garlic, if such exist, and among those recipes, ranks the recipes by the least number of additional non-staple ingredients required.

Had the user indicated CHICKEN and also indicated multiple non-main ingredients, the recipe server 100 would have top ranked all recipes containing chicken and at least one of the indicated non-main ingredients, if such exist.

Generally, if non-main ingredients are indicated by the user in addition to a main ingredient, the recipes which contain the main ingredient are ranked in accordance with formula (1), as follows:

(NUMBER OF USER-INDICATED NON-MAIN INGREDIENTS IN RECIPE*100)/TOTAL INGREDIENT COUNT FOR THE RECIPE (1)

The resulting ranked recipe list is preferably truncated after a predetermined number of highest ranked recipes, typically after the 500th highest ranked recipe, and may be displayed to the user, preferably as a list 150 of links 152. The user may browse the list and select a desired recipe by clicking on it.

If none of the identification codes corresponding to ingredient indications which are inputted by the user to the recipe server 100 relate to main ingredients, the recipe server 100 creates a list of all recipes in the recipe database 102 which include any one or more of the ingredients which are indicated by the user. Generally, the recipes which contain one or more of the ingredients indicated by the user are ranked as follows:

(NUMBER OF USER-INDICATED INGREDIENTS IN RECIPE*100)/TOTAL INGREDIENT COUNT FOR THE RECIPE (2)

The resulting ranked recipe list is preferably truncated after a predetermined number of highest ranked recipes, typically after the 500th highest ranked recipe, and may be displayed to the user, preferably as a list 150 of links 152. The user may browse the list and select a desired recipe by clicking on it.

Following truncating of the ranked recipe list, the recipe server 100 optionally queries the user as to whether various non-user indicated, non-staple ingredients are also available to the user. This is preferably carried out in the following manner: each of the above highest ranked recipes is reviewed. Each non-user indicated, non-staple ingredient appearing in at least one of the highest ranked recipes is ranked by scoring each such ingredient as follows:

The score for each ingredient is the total of the individual scores for that ingredient, wherein an ingredient receives an individual score each time it appears in one of the highest ranked recipes.

Each individual score is computed as follows:

(1/NUMBER OF NON-USER INDICATED, NON-STAPLE INGREDIENTS IN THE RECIPE)² (3)

Thus it is appreciated that non-main, non-staple ingredients which appear in recipes having few other ingredients are given substantially higher scores than non-main, non-staple ingredients which appear in recipes having a relatively large number of other ingredients.

When the recipe server 100 queries the user as to whether various non-user indicated, non-staple ingredients are also available to the user, it presents the candidate ingredients in the order of their ranking.

In the present example, where the user has indicated CHICKEN and GARLIC, the recipe server 100 typically asks the user a question such as “DO YOU HAVE SOY SAUCE, OLIVE OIL OR LEMON”. In the present example, the user indicates that he also has SOY SAUCE.

In response to this additional user indication, the recipe server 100 repeats the steps described hereinabove, and provides an updated list of recipes ranked as described hereinbove.

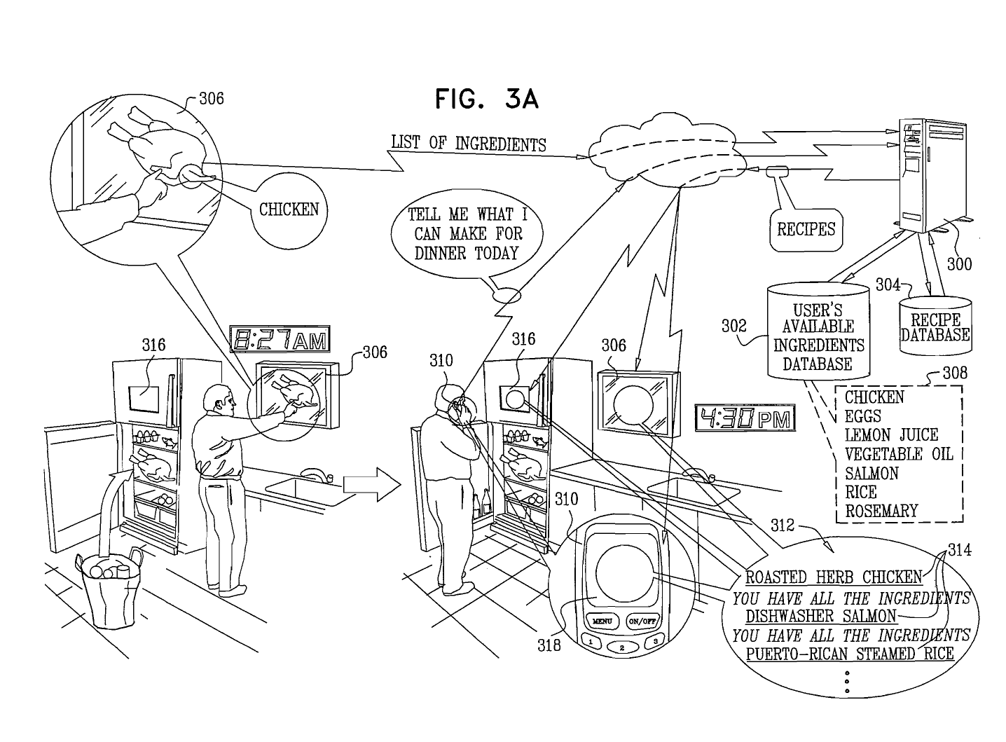

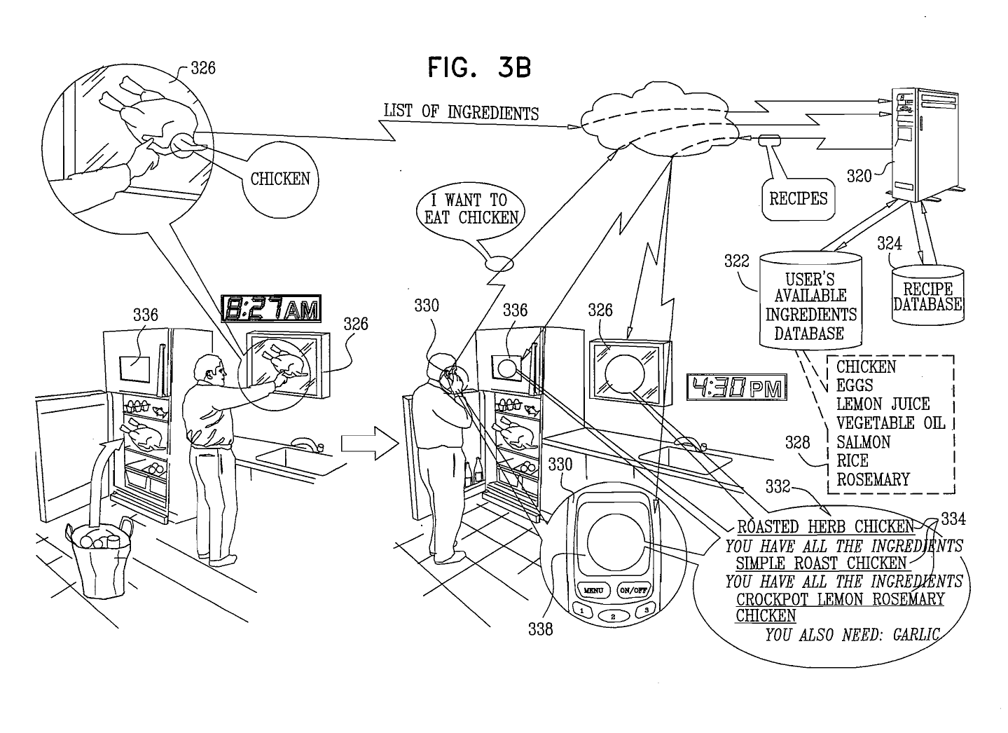

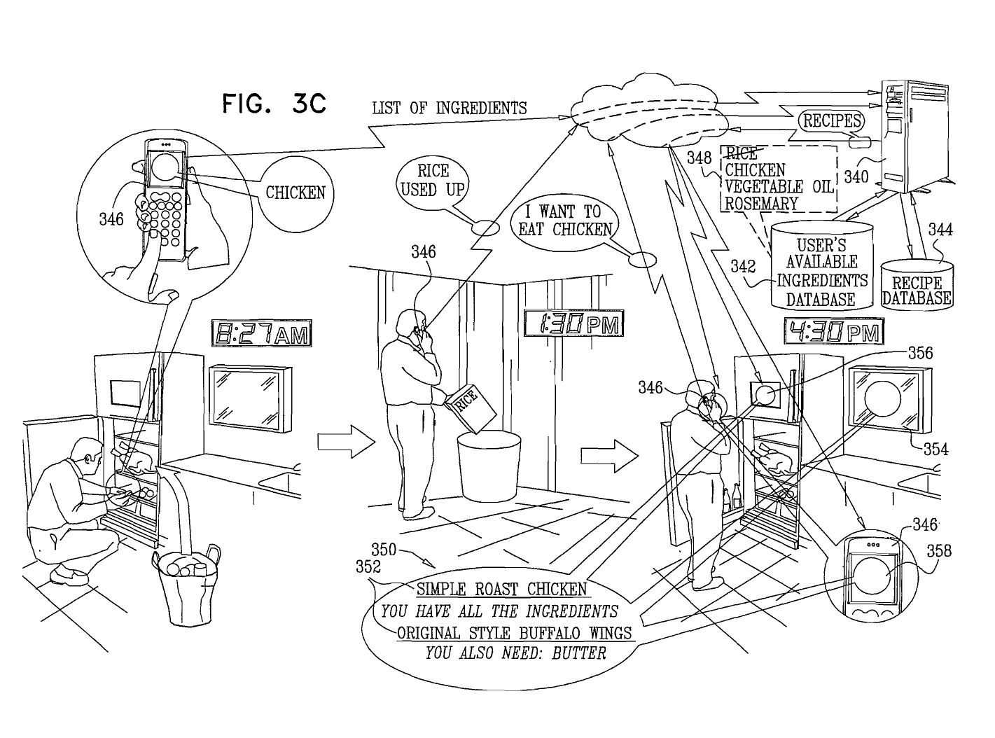

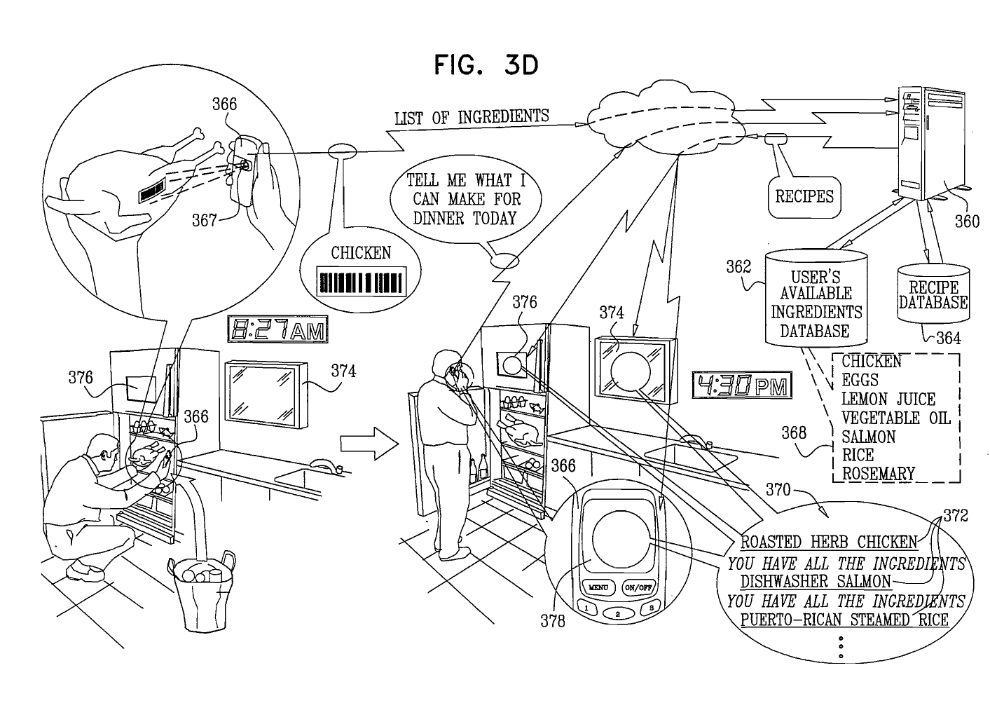

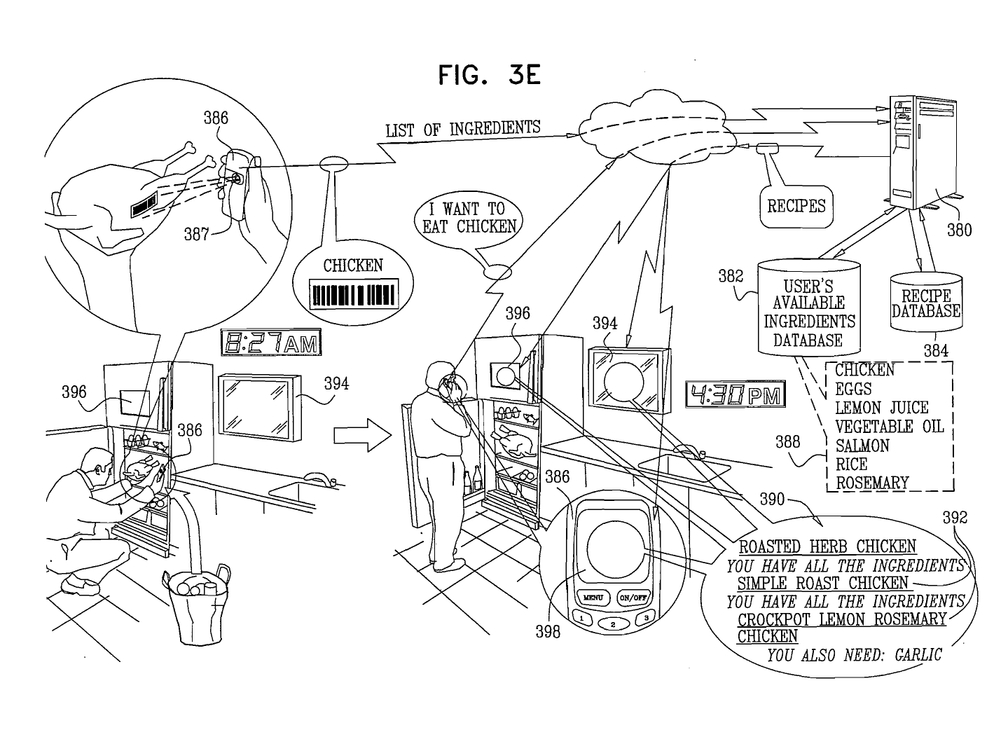

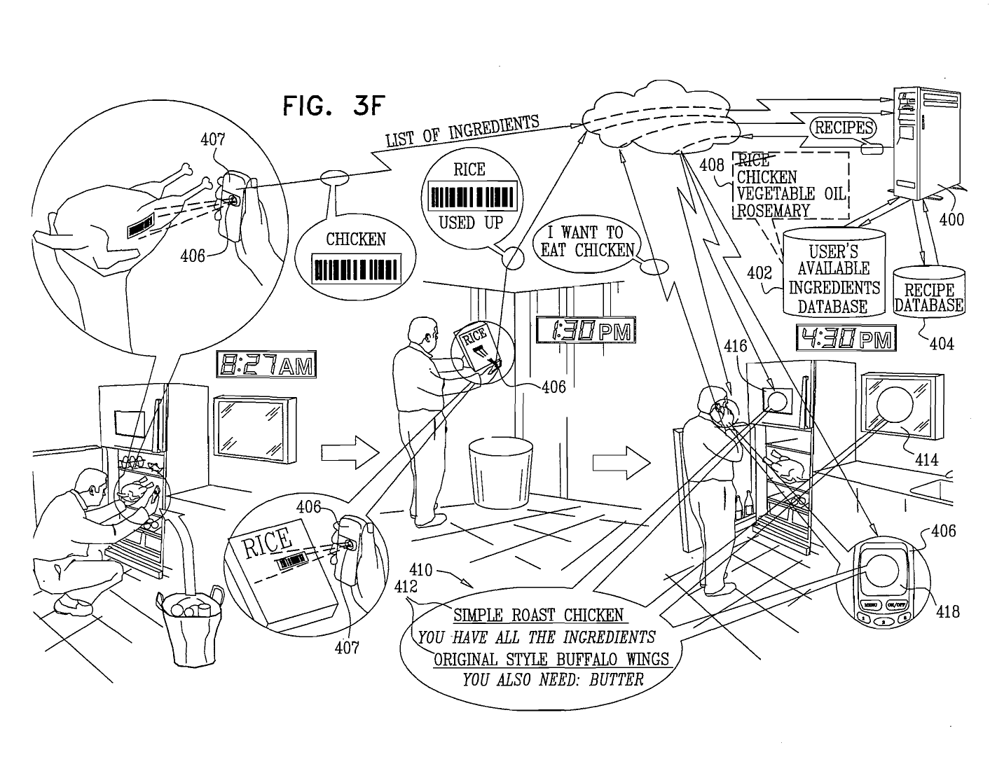

Reference is now made to FIGS. 3A, 3B, 3C, 3D, 3E and 3F, which are simplified pictorial illustrations of six alternative embodiments of a computerized methodology and system for integrated ingredients inventorying and recipe presentation constructed and operative in accordance with a preferred embodiment of the present invention.

As seen in FIG. 3A, a user maintains a computerized inventory of user's available ingredients, typically by communicating with a recipe server 300 having associated therewith a user's available ingredients database 302 as well as a recipe database 304. The communication is preferably by means of a communication network, which is typically a wireless communication network, such as the Internet, via a standard kitchen computer (not shown), having associated therewith a kitchen computer touch-screen display 306. Here the user is shown entering each ingredient by touching a picture of the ingredient on the kitchen computer touch screen display 306, upon returning from the supermarket in the morning, here shown as 8:27 AM, for example. It is appreciated that alternatively this may be done by employing any type of input device associated with a standard computer such as a keyboard, a joystick or a computer mouse. It is further appreciated that alternatively the user may communicate with the recipe server 300 using any other suitable portable communicator functionality, such as by entering each ingredient via the telephone keypad or by voice communication. The user's available ingredients database 302 preferably maintains a cumulative record 308 of all ingredients entered by the user.

Later in the day or at some later date, here shown as 4:30 PM, for example, the user inquires, preferably by voice and using a portable communicator, such as a web-enabled telephone 310, or alternatively using any other suitable communicator functionality, “TELL ME WHAT I CAN MAKE FOR DINNER TODAY”. The user's request is processed by the recipe server 300, which queries the user's available ingredients database 302. In this example, the database 302 indicates that the user has chicken, eggs, lemon juice, vegetable oil, salmon, rice and rosemary. Based on the contents of database 302, the recipe server 300 queries the recipe database 304 for recipes based on these ingredients and provides a list 312 of links 314 to a number of recipes. Preferably, all of the non-staple ingredients of the recipes indicated by links 314 appear in database 302. The links 314 preferably appear on one or more displays, such as kitchen computer display 306, a refrigerator door display 316 and a display 318 of telephone 310. Typical links include ROASTED HERB CHICKEN, DISHWASHER SALMON and PUERTO-RICAN STEAMED RICE.

The user may select one or more recipes by clicking on the appropriate link.

As seen in FIG. 3B, as in FIG. 3A, a user maintains a computerized inventory of user's available ingredients, typically by communicating with a recipe server 320 having associated therewith a user's available ingredients database 322 as well as a recipe database 324. The communication is preferably by means of a communication network, which is typically a wireless communication network, such as the Internet, via a standard kitchen computer (not shown), having associated therewith a kitchen computer touch-screen display 326. Here the user is shown entering each ingredient by touching a picture of the ingredient on the kitchen computer touch screen display 326, upon returning from the supermarket in the morning, here shown as 8:27 AM, for example. It is appreciated that alternatively this may be done by employing any type of input device associated with a standard computer such as a keyboard, a joystick or a computer mouse. It is further appreciated that alternatively the user may communicate with the recipe server 320 using any other suitable portable communicator functionality, such as by entering each ingredient via the telephone keypad or by voice communication. The user's available ingredients database 322 preferably maintains a cumulative record 328 of all ingredients entered by the user.

Later in the day or at some later date, here shown as 4:30 PM, for example, the user states, preferably by voice and using a portable communicator, such as a web-enabled telephone 330, or alternatively using any other suitable communicator functionality, “I WANT TO EAT CHICKEN”. The user's request is processed by the recipe server 320, which queries the user's available ingredients database 322. In this example, the database 322 indicates that the user has chicken, eggs, lemon juice, vegetable oil, salmon, rice and rosemary. Based on the contents of database 322 and on the request of the user for a recipe including CHICKEN, the recipe server 320 queries the recipe database 324 for CHICKEN recipes based on these ingredients and provides a list 332 including links 334 to a number of recipes. Preferably, all of the non-staple ingredients of the recipes indicated by links 334 appear in database 322. The links 334 preferably appear on one or more displays, such as kitchen computer display 326, refrigerator door display 336 and display 338 of telephone 330. Typical links include ROASTED HERB CHICKEN and SIMPLE ROAST CHICKEN. An additional entry, CROCKPOT LEMON ROSEMARY CHICKEN appears with the notation that GARLIC is also required.

The user may select one or more recipes by clicking on the appropriate link.

As seen in FIG. 3C, as in FIGS. 3A and 3B, a user maintains a computerized inventory of user's available ingredients, typically by communicating with a recipe server 340 having associated therewith a user's available ingredients database 342 as well as a recipe database 344. The communication is preferably by means of a cellular telephone network via a portable communicator, such as a web-enabled telephone 346. Here the user is shown entering each ingredient via the telephone keypad upon returning from the supermarket in the morning, here shown as 8:27 AM, for example. It is appreciated that alternatively this may be done using any other suitable communicator functionality, such as voice communication. The user's available ingredients database 342 preferably maintains a cumulative record 348 of all ingredients entered by the user.

In this example, however, the user also updates the user's available ingredients database 342 with information as to ingredients that are no longer available. Here the user is shown indicating that rice is no longer available, orally via the telephone 346, here shown as 1:30 PM, for example.

Later in the day or at some later date, here shown as 4:30 PM, for example, the user states, preferably by voice, or alternatively using any other suitable portable communicator functionality, “I WANT TO EAT CHICKEN”. The user's request is processed by the recipe server 340, which queries the user's available ingredients database 342. In this example, the database 342 indicates that the user has chicken, vegetable oil and rosemary. Based on the contents of database 342 and on the request of the user for a recipe including CHICKEN, the recipe server 340 queries the recipe database 344 for CHICKEN recipes based on these ingredients and provides a list 350 including links 352 to a number of recipes. Preferably, all of the non-staple ingredients included in the recipes indicated by links 352 appear in database 342. These links 352 preferably appear on one or more displays, such as a kitchen computer display 354, a refrigerator door display 356 and a display 358 of telephone 346. A typical link includes SIMPLE ROAST CHICKEN. An additional entry, ORIGINAL STYLE BUFFALO WINGS appears with the notation that BUTTER is also required.

The user may select one or more recipes by clicking on the appropriate link.

As seen in FIG. 3D, a user maintains a computerized inventory of user's available ingredients, typically by communicating with a recipe server 360 having associated therewith a user's available ingredients database 362 as well as a recipe database 364. The communication is preferably by means of a cellular telephone network via a portable communicator, such as a web-enabled telephone 366. Here the user is shown entering each ingredient using a telephone camera 367 which enables reading a barcode on the ingredient either at the telephone 366 or by the server 360, upon returning from the supermarket in the morning, here shown as 8:27 AM, for example. It is appreciated that alternatively this may be done using any other suitable communicator functionality, such as voice communication. The user's available ingredients database 362 preferably maintains a cumulative record 368 of all ingredients entered by the user.

Later in the day or at some later date, here shown as 4:30 PM, for example, the user inquires, preferably by voice, or alternatively using any other suitable portable communicator functionality, “TELL ME WHAT I CAN MAKE FOR DINNER TODAY”. The user's request is processed by the recipe server 360, which queries the user's available ingredients database 362. In this example, the database 362 indicates that the user has chicken, eggs, lemon juice, vegetable oil, salmon, rice and rosemary. Based on the contents of database 362, the recipe server 360 queries the recipe database 364 for recipes based on these ingredients and provides a list 370 of links 372 to a number of recipes. Preferably, all of the non-staple ingredients of the recipes indicated by links 372 appear in database 362. The links 372 preferably appear on one or more displays, such as a kitchen computer display 374, a refrigerator door display 376 and a display 378 of telephone 366. Typical links include ROASTED HERB CHICKEN, DISHWASHER SALMON and PUERTO-RICAN STEAMED RICE.

The user may select one or more recipes by clicking on the appropriate link.

As seen in FIG. 3E, as in FIG. 3D, a user maintains a computerized inventory of user's available ingredients, typically by communicating with a recipe server 380 having associated therewith a user's available ingredients database 382 as well as a recipe database 384. The communication is preferably by means of a cellular telephone network via a portable communicator, such as a web-enabled telephone 386. Here the user is shown entering each ingredient using a telephone camera 387 which enables reading a barcode on the ingredient either at the telephone 386 or by the server 380, upon returning from the supermarket in the morning, here shown as 8:27 AM, for example. It is appreciated that alternatively this may be done using any other suitable communicator functionality, such as voice communication. The user's available ingredients database 382 preferably maintains a cumulative record 388 of all ingredients entered by the user.

Later in the day or at some later date, here shown as 4:30 PM, for example, the user states, preferably by voice, or alternatively using any other suitable portable communicator functionality, “I WANT TO EAT CHICKEN”. The user's request is processed by the recipe server 380, which queries the user's available ingredients database 382. In this example, the database 382 indicates that the user has chicken, eggs, lemon juice, vegetable oil, salmon, rice and rosemary. Based on the contents of database 382 and on the request of the user for a recipe including CHICKEN, the recipe server 380 queries the recipe database 384 for CHICKEN recipes based on these ingredients and provides a list 390 of links 392 to a number of recipes. Preferably, all of the non-staple ingredients of the recipes indicated by links 392 appear in database 382. These links preferably appear on one or more displays, such as a kitchen computer display 394, a refrigerator door display 396 and a display 398 of telephone 386. Typical links include ROASTED HERB CHICKEN and SIMPLE ROAST CHICKEN. An additional entry, CROCKPOT LEMON ROSEMARY CHICKEN appears with the notation that GARLIC is also required.

The user may select one or more recipes by clicking on the appropriate link.

As seen in FIG. 3F, as in FIGS. 3D and 3E, a user maintains a computerized inventory of user's available ingredients, typically by communicating with a recipe server 400 having associated therewith a user's available ingredients database 402 as well as a recipe database 404. The communication is preferably by means of a cellular telephone network via a portable communicator, such as a web-enabled telephone 406. Here the user is shown entering each ingredient using a telephone camera 407 which enables reading a barcode on the ingredient either at the telephone 406 or by the server 400, upon returning from the supermarket in the morning, here shown as 8:27 AM, for example. It is appreciated that alternatively this may be done using any other suitable communicator functionality, such as voice communication. The user's available ingredients database 402 preferably maintains a cumulative record 408 of all ingredients entered by the user.

In this example, however, the user also updates the user's available ingredients database 402 with information as to ingredients that are no longer available. Here the user is shown indicating that rice is no longer available, using the telephone camera 407 of web-enabled telephone 406, which enables reading a barcode on the ingredient either at the telephone 406 or by the server 400, here shown as 1:30 PM, for example.

Later in the day or at some later date, here shown as 4:30 PM, for example, the user states, preferably by voice, or alternatively using any other suitable portable communicator functionality, “I WANT TO EAT CHICKEN”. The user's request is processed by the recipe server 400, which queries the user's available ingredients database 402. In this example, the database 402 indicates that the user has chicken, vegetable oil and rosemary. Based on the contents of database 402 and on the request of the user for a recipe including CHICKEN, the recipe server 400 queries the recipe database 404 for CHICKEN recipes based on these ingredients and provides a list 410 of links 412 to a number of recipes. Preferably, all of the non-staple ingredients of the recipes indicated by links 412 appear in database 402. The links 412 preferably appear on one or more displays, such as a kitchen computer display 414, a refrigerator door display 416 and a display 418 of telephone 406. A typical link includes SIMPLE ROAST CHICKEN. An additional entry, ORIGINAL STYLE BUFFALO WINGS appears with the notation that BUTTER is also required.

The user may select one or more recipes by clicking on the appropriate link.

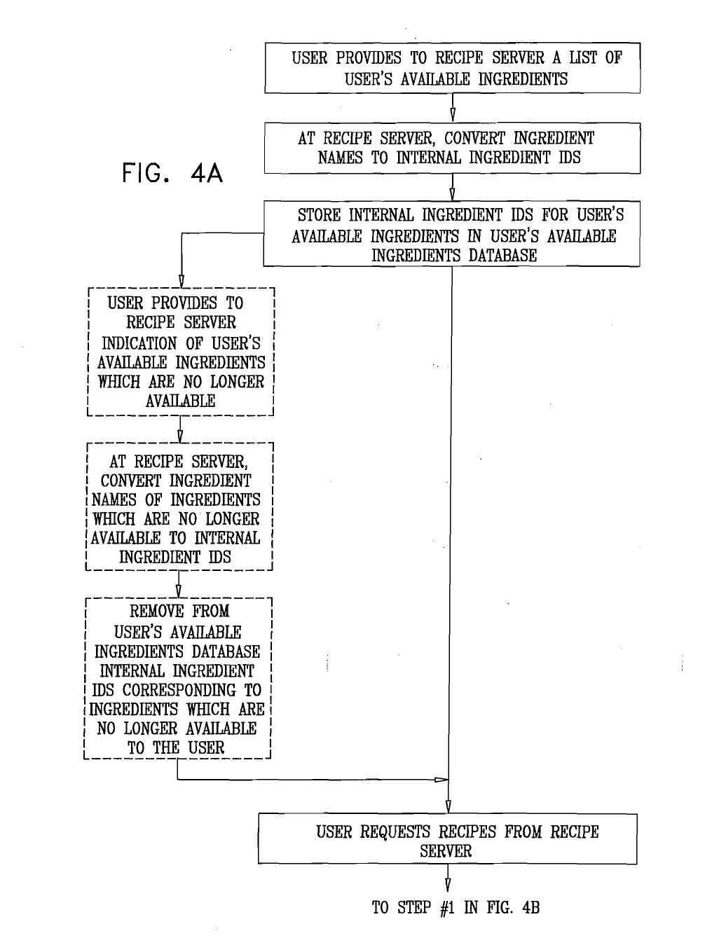

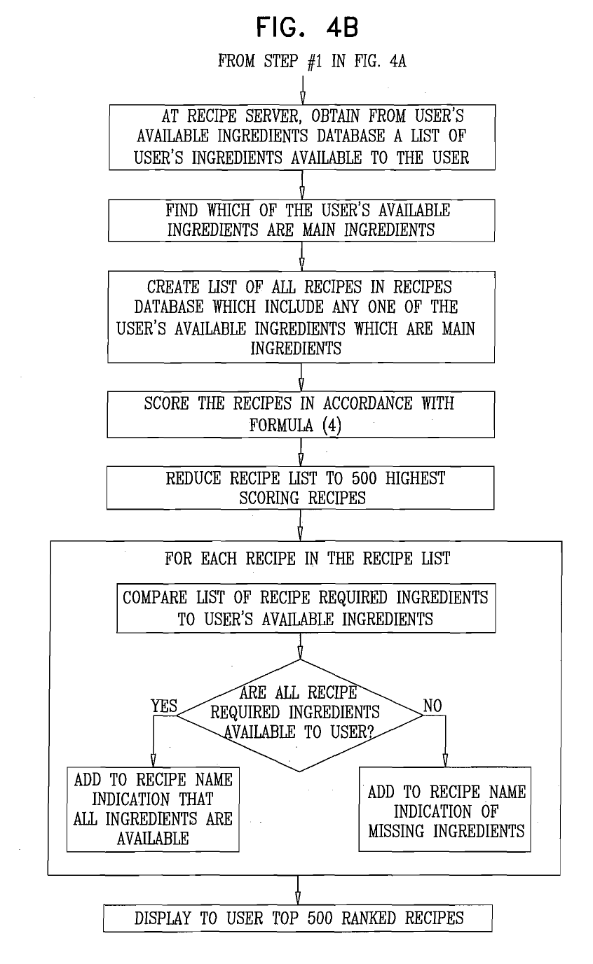

Reference is now made to FIGS. 4A and 4B, which together are a simplified flow chart illustrating the operation of the methodology and system of FIGS. 3A and 3D.

As seen in FIG. 4A, a user provides to a recipe server, such as recipe server 300 (FIG. 3A), a computerized inventory including indications of the user's available ingredients. The recipe server is preferably operative to convert the received indications of the user's available ingredients to corresponding internal ingredient identification codes and to store these internal ingredients identification codes in a user's record in a user's available ingredients database, such as database 302 (FIG. 3A).

At the same time or at any other time, the user may optionally provide to the recipe server an indication of user's available ingredients which are no longer available. The recipe server is preferably operative to convert the received indications of the no longer available ingredients to corresponding internal ingredient identification codes and to update the user's record in the user's available ingredients database to remove these internal ingredients identification codes from the user's record.

Turning to FIG. 4B, it is seen that at any time when the user requests recipes which can be made with the user's available ingredients, the recipe server processes the user's request and obtains from the user's available ingredients database a list of the internal ingredient identification codes corresponding to the user's available ingredients. The recipe server then reviews the identification codes corresponding to the user's available ingredients and finds the identification codes which relate to main ingredients. Subsequently, the recipe server creates a list of all recipes in a recipe database associated with the recipe server, such as recipe database 304 (FIG. 3A), which include any one or more of the main ingredients which are available to the user.

The recipe server then notes the identification of the non-main ingredients in the user's available ingredients list, and ranks the recipes in the recipes list as follows:

(NUMBER OF NON-MAIN INGREDIENTS IN THE LIST OF USER'S AVAILABLE INGREDIENTS WHICH ARE IN THE RECIPE*100)/TOTAL INGREDIENT COUNT FOR THE RECIPE (4)

The resulting ranked recipe list is preferably truncated after a predetermined number of highest ranked recipes, typically after the 500th highest ranked recipe. Preferably, the ingredients included in each of the recipes are compared to the user's available ingredients list. If all the ingredients required for the recipe are available to the user, an indication that the user has all the required ingredients is added to the recipe name in the recipe list. If some of the ingredients required for the recipe are not available to the user, an indication of the missing ingredients is added to the recipe name in the recipe list. The recipe list with the added indications of missing ingredients may be displayed to the user, preferably as a list of links. The user may browse the list and select a desired recipe by clicking on it.

It is appreciated that if the user's available ingredients do not include any main ingredients, the recipe database provides the user with a list of recipes including one or more of the ingredients available to the user, in a similar manner to that described hereinabove with reference to the case in FIGS. 2A and 2B in which the user does not provide indications of non main ingredients.

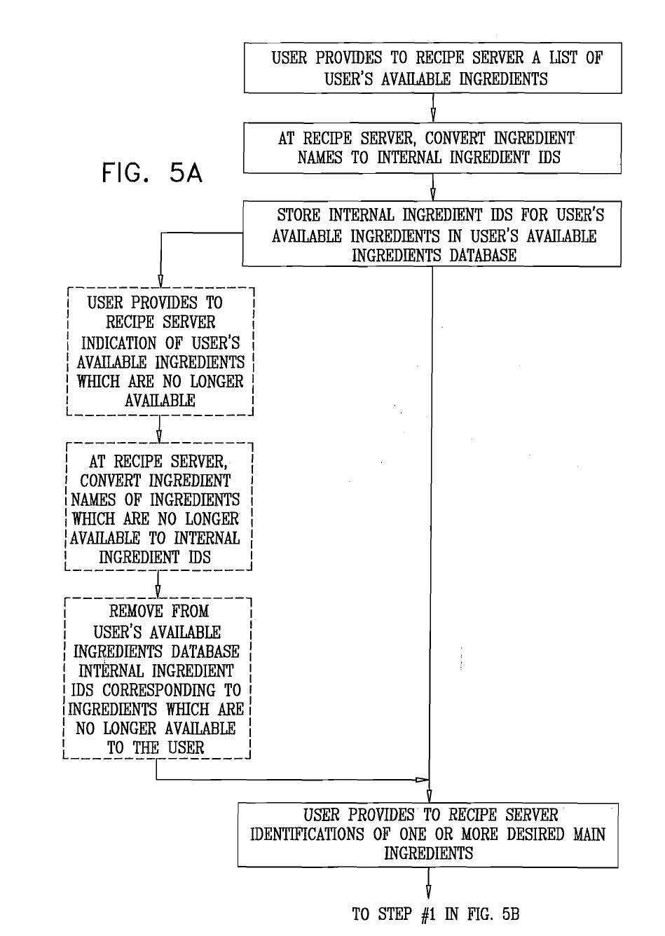

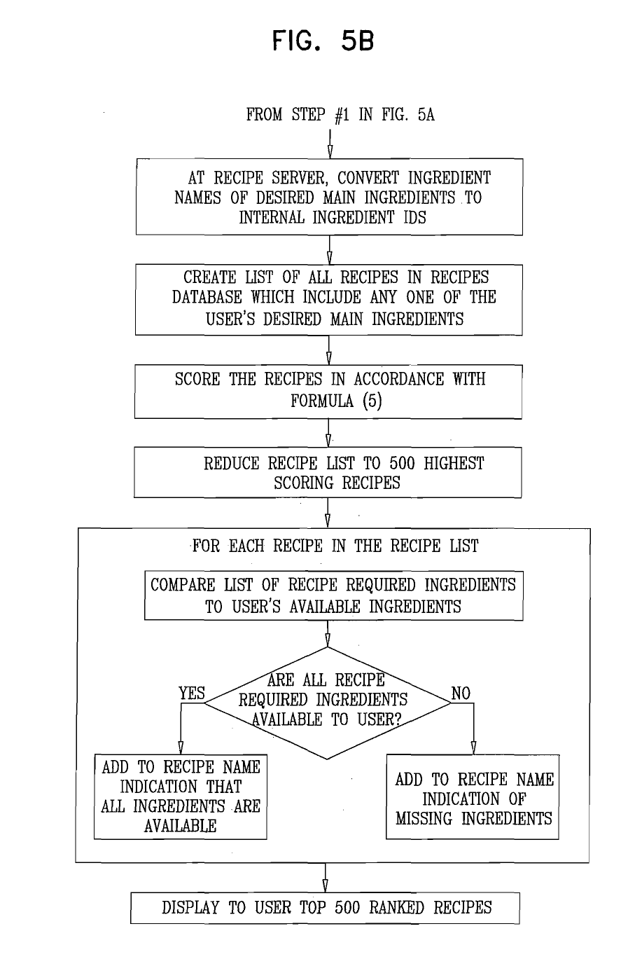

Reference is now made to FIGS. 5A and 5B, which together are a simplified flow chart illustrating the operation of the methodology and system of FIGS. 3B, 3C, 3E and 3F.

As seen in FIG. 5A, a user provides to a recipe server, such as recipe server 320 (FIG. 3B), a computerized inventory including indications of the user's available ingredients. The recipe server is preferably operative to convert the received indications of the user's available ingredients to corresponding internal ingredient identification codes and to store these internal ingredients identification codes in a user's record in a user's available ingredients database, such as database 322 (FIG. 3B).

At the same time or at any other time, the user may optionally provide to the recipe server an indication of user's available ingredients which are no longer available. The recipe server is preferably operative to convert the received indications of the no longer available ingredients to corresponding internal ingredient identification codes and to update the user's record in the user's available ingredients database to remove these internal ingredients identification codes from the user's record.

The user then provides to the recipe server an indication of one or more desired main ingredients which are available to the user. Turning to FIG. 5B, it is seen that the recipe server is preferably operative to convert the received indications of the desired main ingredients to corresponding internal ingredient identification codes, and obtains from a recipe database associated with the recipe server, such as recipe database 324 (FIG. 3B), a list of recipes which include any one or more of the user desired main ingredients. The recipe server additionally obtains from the user's available ingredients database a list of all non-main ingredients which are available to the user, and ranks the recipes in the recipes list as follows:

(NUMBER OF NON-MAIN INGREDIENTS IN THE LIST OF USER'S AVAILABLE INGREDIENTS WHICH ARE IN THE RECIPE*100)/TOTAL INGREDIENT COUNT FOR THE RECIPE (5)

The resulting ranked recipe list is preferably truncated after a predetermined number of highest ranked recipes, typically after the 500th highest ranked recipe. Preferably, the ingredients included in each of the recipes are compared to the user's available ingredients list. If all the ingredients required for the recipe are available to the user, an indication that the user has all the required ingredients is added to the recipe name in the recipe list. If some of the ingredients required for the recipe are not available to the user, an indication of the missing ingredients is added to the recipe name in the recipe list. The recipe list with the added indications of missing ingredients may be displayed to the user, preferably as a list of links. The user may browse the list and select a desired recipe by clicking on it.

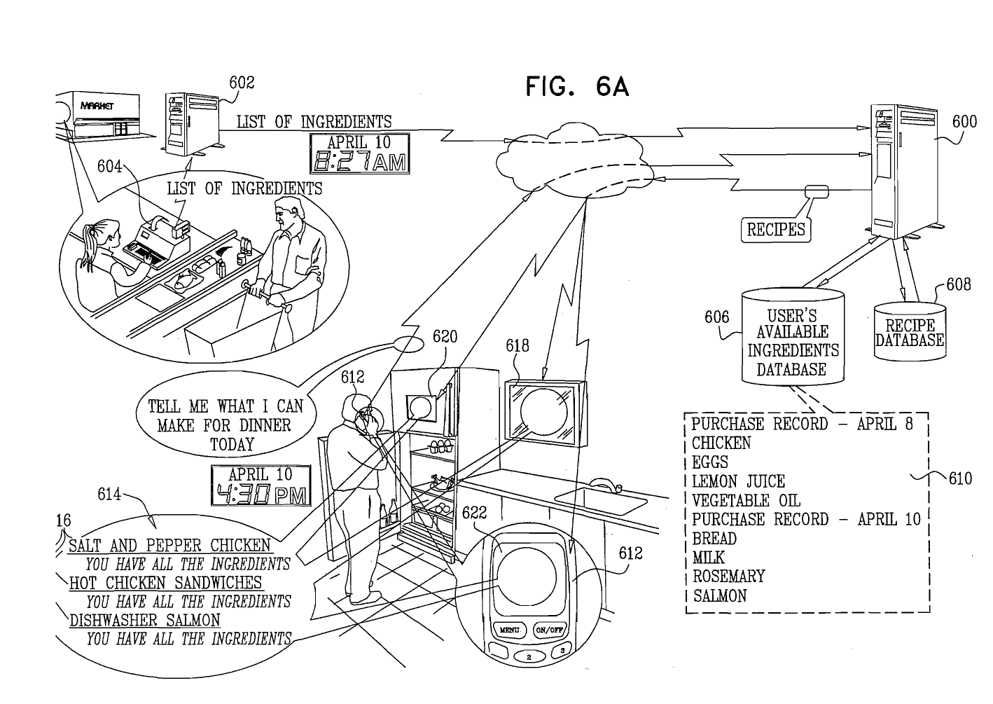

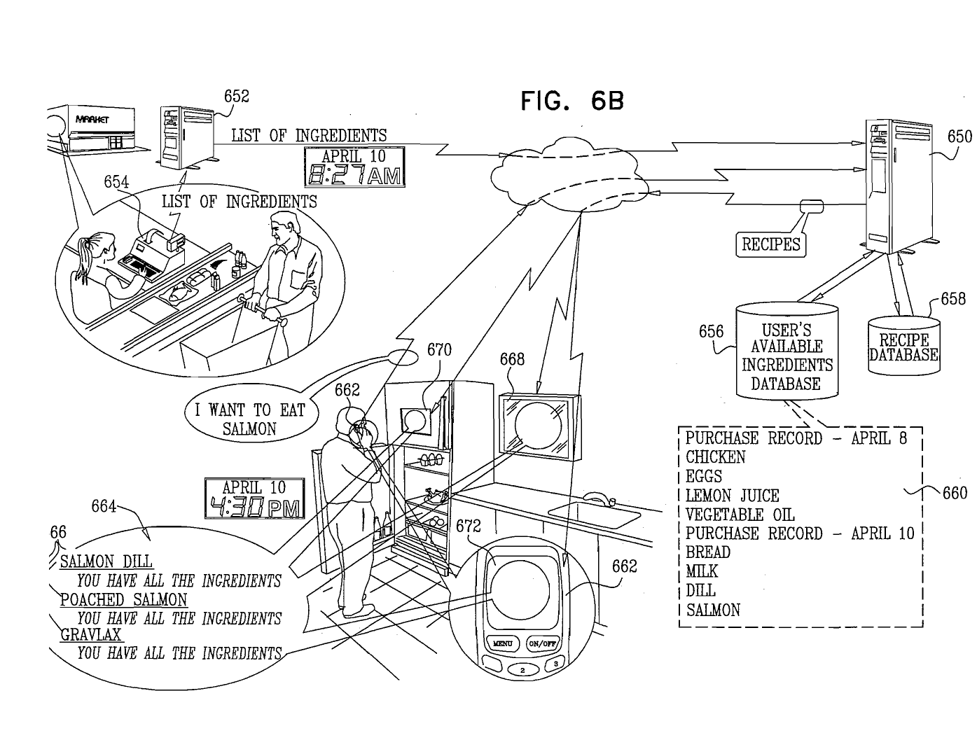

Reference is now made to FIGS. 6A and 6B, which are simplified pictorial illustrations of two alternative embodiments of a computerized methodology and system for integrated point of sale monitoring, ingredients inventorying and recipe presentation constructed and operative in accordance with a preferred embodiment of the present invention.

As seen in FIG. 6A, a user maintains a computerized inventory of user's available ingredients, typically by communicating with a recipe server 600 via a point of sale server 602 which is associated with a point of sale terminal 604. The recipe server 600 preferably has associated therewith a user's available ingredients database 606 as well as a recipe database 608. The communication is preferably by means of a communication network, which is typically a wireless communication network, such as the Internet. Here the user is shown at the point of sale in a super-market, where a cashier enters each ingredient bought by the user into the point of sale terminal 604 in the morning, here shown as April 10 at 8:27 AM, for example. As seen, the list of ingredients entered into the point of sale terminal 604 is communicated via the point of sale server 602 to the recipe server 600. The user's available ingredients database 606 preferably maintains a cumulative record 610 of all ingredients entered by the user. As seen, the record 610 includes a listing of ingredients bought by the user on April 8, which includes chicken, eggs, lemon juice and vegetable oil, as well as a listing of ingredients bought by the user on April 10, which includes bread, milk, rosemary and salmon.

Later in the day or at some later date, here shown as April 10 at 4:30 PM, for example, the user inquires, preferably by voice and using a portable communicator, such as a web-enabled telephone 612, or alternatively using any other suitable communicator functionality, “TELL ME WHAT I CAN MAKE FOR DINNER TODAY”. The user's request is processed by the recipe server 600, which queries the user's available ingredients database 606. In this example, the database 606 indicates that the user has chicken, eggs, lemon juice, vegetable oil, bread, milk, rosemary and salmon. Based on the contents of database 606, the recipe server 600 queries the recipe database 608 for recipes based on these ingredients and provides a list 614 of links 616 to a number of recipes. Preferably, all of the non-staple ingredients of the recipes indicated by links 616 appear in database 606. The links 616 preferably appear on one or more displays, such as kitchen computer display 618, a refrigerator door display 620 and a display 622 of mobile telephone 612. Typical links include SALT AND PEPPER CHICKEN, HOT CHICKEN SANDWICHES and DISHWASHER SALMON.

The user may select one or more recipes by clicking on the appropriate link.

As seen in FIG. 6B, as in FIG. 6A, a user maintains a computerized inventory of user's available ingredients, typically by communicating with a recipe server 650 via a point of sale server 652 which is associated with a point of sale terminal 654. The recipe server 650 preferably has associated therewith a user's available ingredients database 656 as well as a recipe database 658. The communication is preferably by means of a communication network, which is typically a wireless communication network, such as the Internet. Here the user is shown at the point of sale in a supermarket, where a cashier enters each ingredient bought by the user into the point of sale terminal 654 in the morning, here shown as April 10 at 8:27 AM, for example. As seen, the list of ingredients entered into the point of sale terminal 654 is communicated via the point of sale server 652 to the recipe server 650. The user's available ingredients database 656 preferably maintains a cumulative record 660 of all ingredients entered by the user. As seen, the record 660 includes a listing of ingredients bought by the user on April 8, which includes chicken, eggs, lemon juice and vegetable oil, as well as a listing of ingredients bought by the user on April 10, which includes bread, milk, dill and salmon.

Later in the day or at some later date, here shown as April 10 at 4:30 PM, for example, the user states, preferably by voice and using a portable communicator, such as a web-enabled telephone 662, or alternatively using any other suitable portable communicator functionality, “I WANT TO EAT SALMON”. The user's request is processed by the recipe server 650, which queries the user's available ingredients database 656. In this example, the database 656 indicates that the user has chicken, eggs, lemon juice, vegetable oil, bread, milk, dill and salmon. Based on the contents of database 656 and on the request of the user for a recipe including SALMON, the recipe server 650 queries the recipe database 658 for SALMON recipes based on these ingredients and provides a list 664 including links 666 to a number of recipes. Preferably, all of the non-staple ingredients of the recipes indicated by links 666 appear in database 656. The links 666 preferably appear on one or more displays, such as kitchen computer display 668, refrigerator door display 670 and display 672 of telephone 662. Typical links include SALMON DILL, POACHED SALMON and GRAVLAX.

The user may select one or more recipes by clicking on the appropriate link.

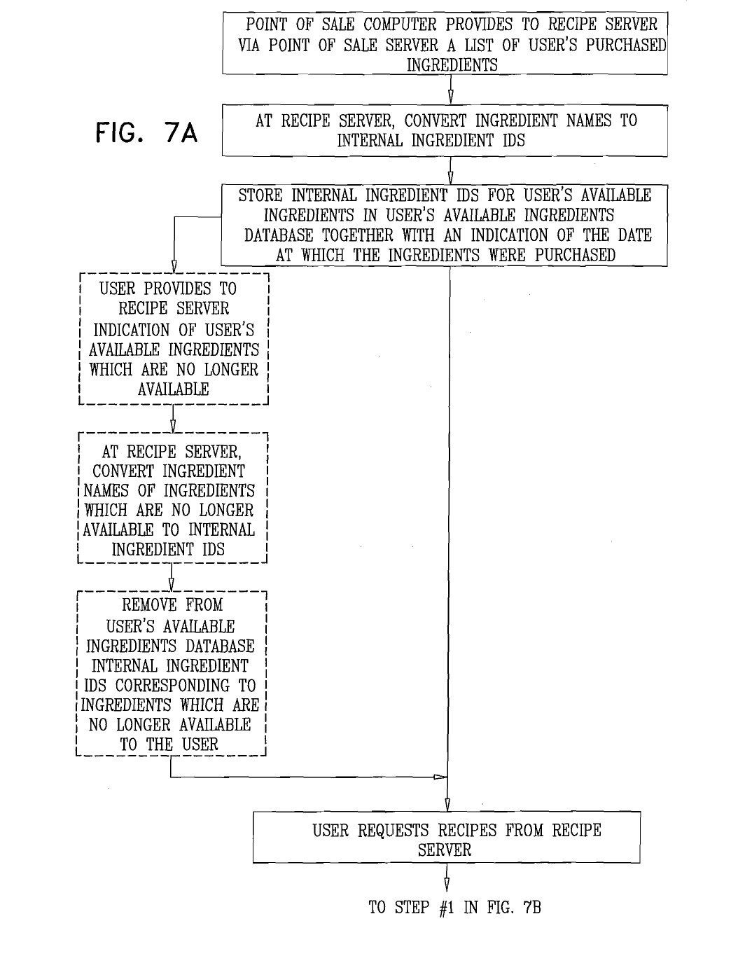

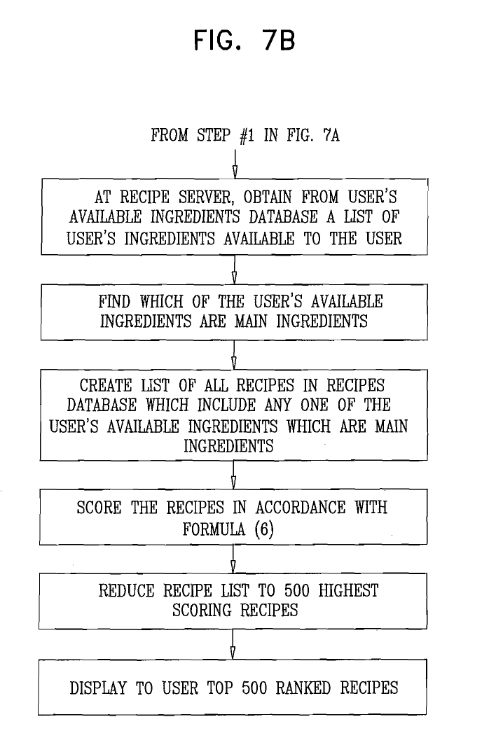

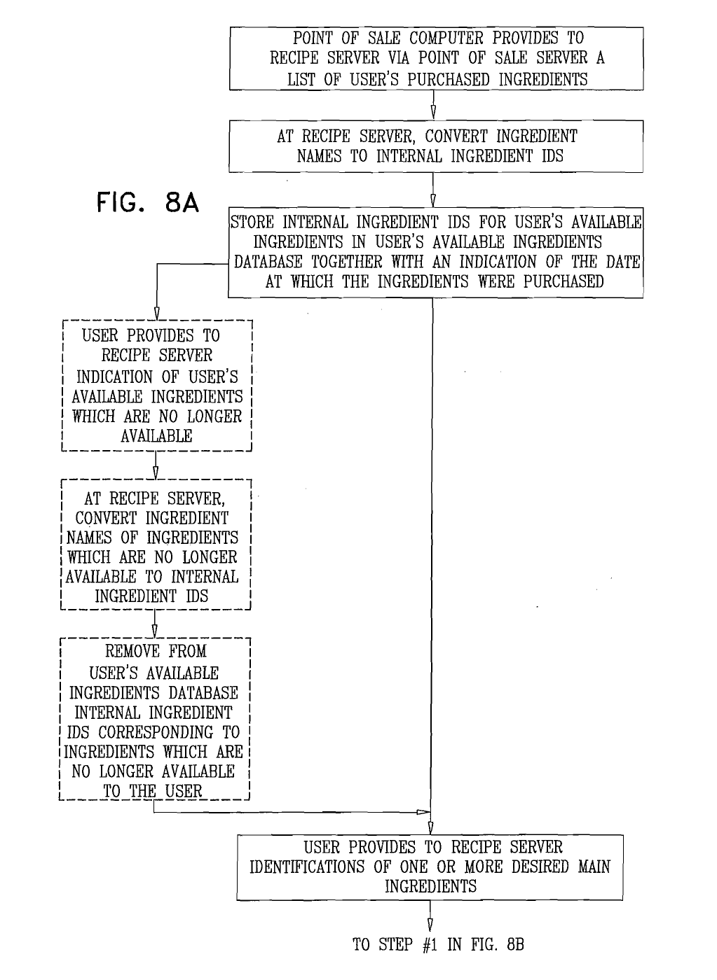

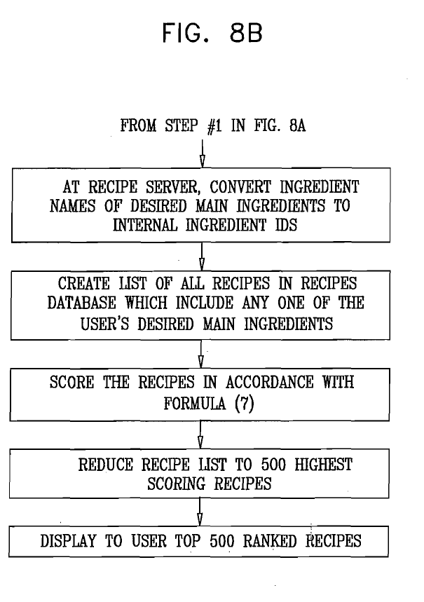

It is appreciated that the functionality whereby a user updates the user's available ingredients database when ingredients are no longer available, as described hereinabove with reference to FIGS. 3C and 3F, may also be combined with the ingredients inventorying and recipe presentation functionality described hereinabove with reference to FIGS. 6A and 6B, as described further hereinbelow with reference to FIGS. 7A, 7B, 8A and 8B.

Reference is now made to FIGS. 7A and 7B, which together are a simplified flow chart illustrating the operation of the methodology and system of FIG. 6A.

As seen in FIGS. 7A and 7B, a computerized inventory including indications of user purchased ingredients is provided from a point of sale terminal, such as point of sale terminal 604 (FIG. 6A), to a recipe server, such as recipe server 600 (FIG. 6A), via a point of sale server, such as point of sale server 602 (FIG. 6A).

The recipe server is preferably operative to convert the received indications of the user's purchased ingredients to corresponding internal ingredient identification codes and to store these internal ingredients identification codes as updates to a user's record in a user's available ingredients database, such as database 606 (FIG. 6A). Preferably, the user's record includes, for each given ingredient listed therein, the date at which the user's record was updated to include the indication of the given ingredient.

At the same time or at any other time, the user may optionally provide to the recipe server an indication of user's available ingredients which are no longer available. The recipe server is preferably operative to convert the received indications of the no longer available ingredients to corresponding internal ingredient identification codes and to update the user's record in the user's available ingredients database to remove these internal ingredients identification codes from the user's record.

At any time when the user requests recipes which can be made with the user's available ingredients, the recipe server processes the user's request and obtains from the user's available ingredients database a list of the internal ingredient identification codes corresponding to the user's available ingredients. The recipe server then reviews the identification codes corresponding to the user's available ingredients and finds the identification codes which relate to main ingredients. Subsequently, the recipe server creates a list of all recipes in a recipe database associated with the recipe server, such as recipe database 608 (FIG. 6A), which include any one or more of the main ingredients which are available to the user.

The recipe server then notes the identification of the non-main ingredients in the user's available ingredients list, and ranks the recipes in the recipes list as follows:

(NUMBER OF NON-MAIN INGREDIENTS IN THE LIST OF USER'S AVAILABLE INGREDIENTS WHICH ARE IN THE RECIPE*100)/TOTAL INGREDIENT COUNT FOR THE RECIPE (6)

The resulting ranked recipe list is preferably truncated after a predetermined number of highest ranked recipes, typically after the 500th highest ranked recipe, and may be displayed to the user, preferably as a list of links. The user may browse the list and select a desired recipe by clicking on it.

It is appreciated that if the user's available ingredients do not include any main ingredients, the recipe database provides the user with a list of recipes including one or more of the ingredients available to the user, in a similar manner to that described hereinabove with reference to the case in FIGS. 2A and 2B in which the user does not provide indications of non main ingredients.

Reference is now made to FIGS. 8A and 8B, which together are a simplified flow chart illustrating the operation of the methodology and system of FIG. 6B.

As seen in FIGS. 8A and 8B, a computerized inventory including indications of user purchased ingredients is provided from a point of sale terminal, such as point of sale terminal 654 (FIG. 6B), to a recipe server, such as recipe server 650 (FIG. 6B), via a point of sale server, such as point of sale server 652 (FIG. 6B).

The recipe server is preferably operative to convert the received indications of the user's purchased ingredients to corresponding internal ingredient identification codes and to store these internal ingredients identification codes as updates to a user's record in a user's available ingredients database, such as database 656 (FIG. 6B). Preferably, the user's record includes, for each given ingredient listed therein, the date at which the user's record was updated to include the indication of the given ingredient.

At the same time or at any other time, the user may optionally provide to the recipe server an indication of user's available ingredients which are no longer available. The recipe server is preferably operative to convert the received indications of the no longer available ingredients to corresponding internal ingredient identification codes and to update the user's record in the user's available ingredients database to remove these internal ingredients identification codes from the user's record.

The user then provides to the recipe server an indication of one or more desired main ingredients which are available to the user. The recipe server is preferably operative to convert the received indications of the desired main ingredients to corresponding internal ingredient identification codes, and obtains from a recipe database associated with the recipe server, such as recipe database 658 (FIG. 6B), a list of recipes which include any one or more of the user desired main ingredients. The recipe server additionally obtains from the user's available ingredients database a list of all non-main ingredients which are available to the user, and ranks the recipes in the recipes list as follows:

(NUMBER OF NON-MAIN INGREDIENTS IN THE LIST OF USER'S AVAILABLE INGREDIENTS WHICH ARE IN THE RECIPE*100)/TOTAL INGREDIENT COUNT FOR THE RECIPE (7)

The resulting ranked recipe list is preferably truncated after a predetermined number of highest ranked recipes, typically after the 500th highest ranked recipe, and may be displayed to the user, preferably as a list of links. The user may browse the list and select a desired recipe by clicking on it.

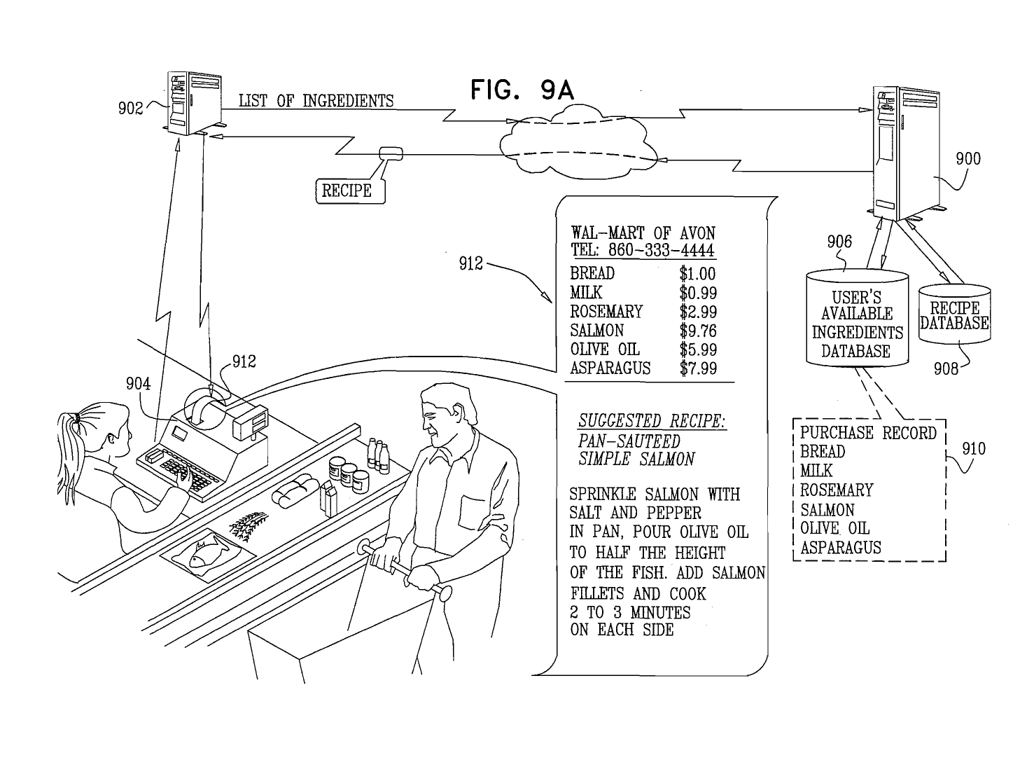

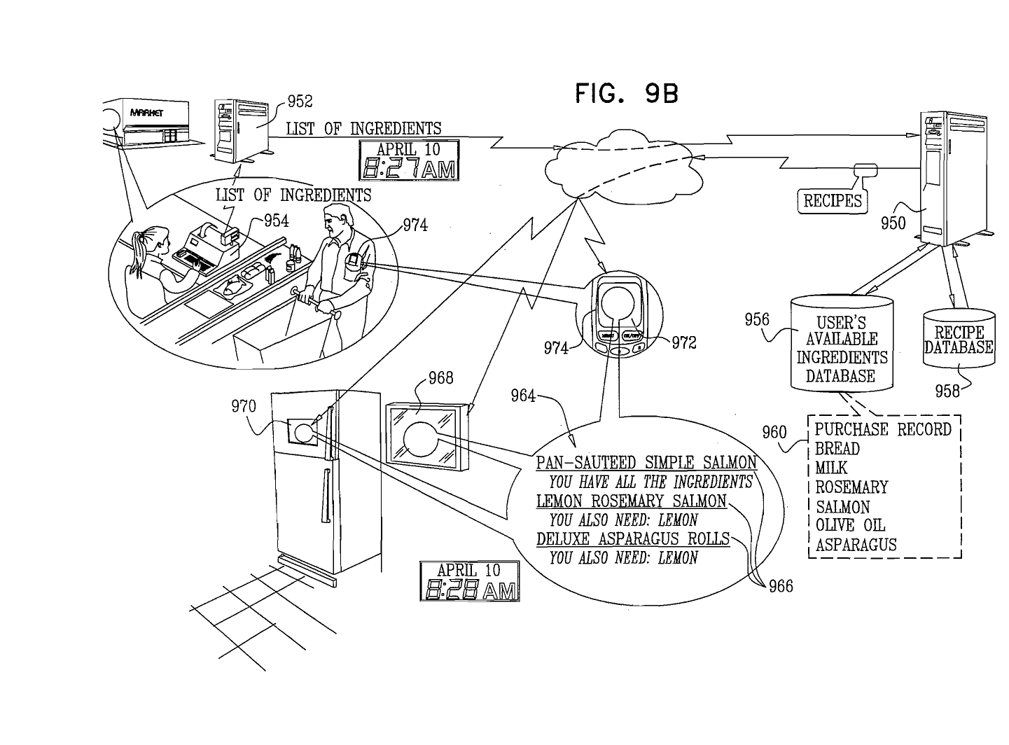

Reference is now made to FIGS. 9A and 9B, which are simplified pictorial illustrations of two alternative embodiments of a computerized methodology and system for integrated point of sale monitoring, ingredients inventorying and multi-media recipe presentation constructed and operative in accordance with a preferred embodiment of the present invention.

As seen in FIG. 9A, a user maintains a computerized inventory of user's available ingredients, typically by communicating with a recipe server 900 via a point of sale server 902 which is associated with a point of sale terminal 904. The recipe server 900 preferably has associated therewith a user's available ingredients database 906 as well as a recipe database 908. The communication is preferably by means of a communication network, which is typically a wireless communication network, such as the Internet. Here the user is shown at the point of sale in a super-market, where a cashier enters each ingredient bought by the user into the point of sale terminal 904. As seen, the list of ingredients entered into the point of sale terminal 904 is communicated via the point of sale server 902 to the recipe server 900. The user's available ingredients database 906 preferably maintains a cumulative record 910 of all ingredients entered by the user.

Generally simultaneously, the recipe server 900 queries the user's available ingredients database 906. In this example, the database 906 indicates that the user has bread, milk, rosemary, salmon, olive oil and asparagus. Based on the contents of database 906, the recipe server 900 queries the recipe database 908 for recipes based on these ingredients. The most suitable recipes found are communicated back to the point of sale terminal 904 via the point of sale server 902, and are printed on a purchase receipt 912 which is given to the user before he leaves the store. In the present example, a recipe for PAN-SAUTEED SIMPLE SALMON is printed on the user's receipt.

As seen in FIG. 9B, as in FIG. 9A, a user maintains a computerized inventory of user's available ingredients, typically by communicating with a recipe server 950 via a point of sale server 952 which is associated with a point of sale terminal 954. The recipe server 950 preferably has associated therewith a user's available ingredients database 956 as well as a recipe database 958. The communication is preferably by means of a communication network, which is typically a wireless communication network, such as the Internet. Here the user is shown at the point of sale in a supermarket, where a cashier enters each ingredient bought by the user into the point of sale terminal 954. As seen, the list of ingredients entered into the point of sale terminal 954 is communicated via the point of sale server 952 to the recipe server 950. The user's available ingredients database 956 preferably maintains a cumulative record 960 of all ingredients entered by the user.

Generally simultaneously, the recipe server 950 queries the user's available ingredients database 956. In this example, the database 956 indicates that the user has bread, milk, rosemary, salmon, olive oil and asparagus. Based on the contents of database 956, the recipe server 950 queries the recipe database 958 for recipes based on these ingredients and provides a list 964 including links 966 to a number of recipes. Preferably, all of the non-staple ingredients of the recipes indicated by links 966 appear in database 956. The links 966 preferably appear on one or more displays, such as kitchen computer display 968, refrigerator door display 970 and display 972 of a telephone 974. Typical links include PAN-SAUTEED SIMPLE SALMON. Additional entries, LEMON ROSEMARY SALMON and DELUXE ASPARAGUS ROLLS appear with the notation that LEMON is also required.

The user may select one or more recipes by clicking on the appropriate link.

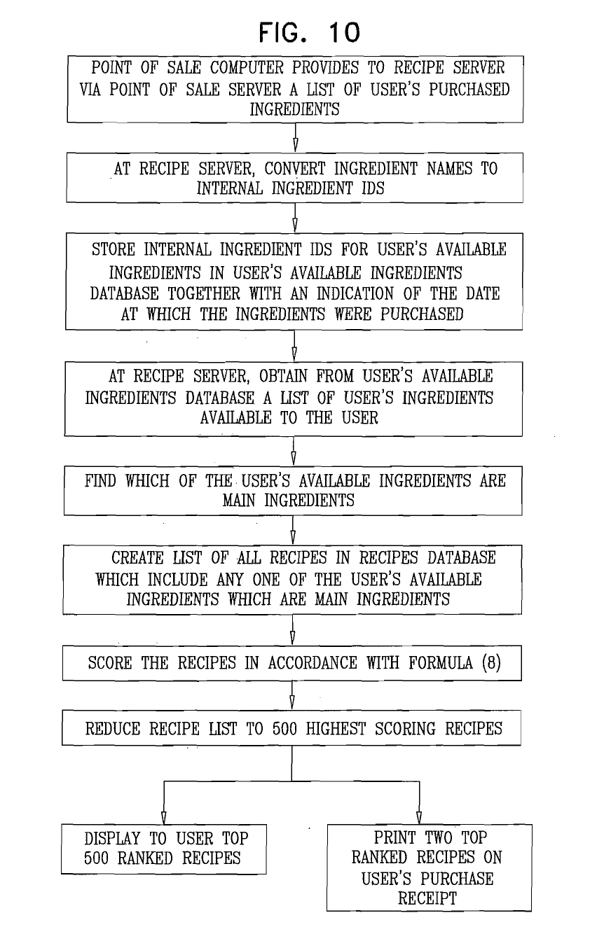

Reference is now made to FIG. 10, which is a simplified flow chart illustrating the operation of the methodology and system of FIGS. 9A and 9B.

As seen in FIG. 10, a computerized inventory including indications of user purchased ingredients is provided from a point of sale terminal, such as point of sale terminal 904 (FIG. 9A), to a recipe server, such as recipe server 900 (FIG. 9A), via a point of sale server, such as point of sale server 902 (FIG. 9A).

The recipe server is preferably operative to convert the received indications of the user's purchased ingredients to corresponding internal ingredient identification codes and to store these internal ingredients identification codes as updates to a user's record in a user's available ingredients database, such as database 906 (FIG. 9A). Preferably, the user's record includes, for each given ingredient listed therein, the date at which the user's record was updated to include the indication of the given ingredient.

Preferably generally simultaneously, but possibly at any later stage, the recipe server obtains from the user's available ingredients database a list of the internal ingredient identification codes corresponding to the user's available ingredients. The recipe server then reviews the identification codes corresponding to the user's available ingredients and finds the identification codes which relate to main ingredients. Subsequently, the recipe server creates a list of all recipes in a recipe database associated with the recipe server, such as recipe database 908 (FIG. 9A), which include any one or more of the main ingredients which are available to the user.

The recipe server then notes the identification of the non-main ingredients in the user's available ingredients list, and ranks the recipes in the recipes list as follows:

(NUMBER OF NON-MAIN INGREDIENTS IN THE LIST OF USER'S AVAILABLE INGREDIENTS WHICH ARE IN THE RECIPE*100)/TOTAL INGREDIENT COUNT FOR THE RECIPE (8)

The resulting ranked recipe list is preferably truncated after a predetermined number of highest ranked recipes, typically after the 500th highest ranked recipe. A predetermined number of the top ranked recipes, typically two or three, are preferably printed on the user's purchase receipt. Additionally or alternatively, the ranked recipes may be displayed to the user, preferably as a list of links. The user may browse the list and select a desired recipe by clicking on it.

It is appreciated that if the user's available ingredients do not include any main ingredients, the recipe database provides the user with a list of recipes including one or more of the ingredients available to the user, in a similar manner to that described hereinabove with reference to the case in FIGS. 2A and 2B in which the user does not provide indications of non main ingredients.

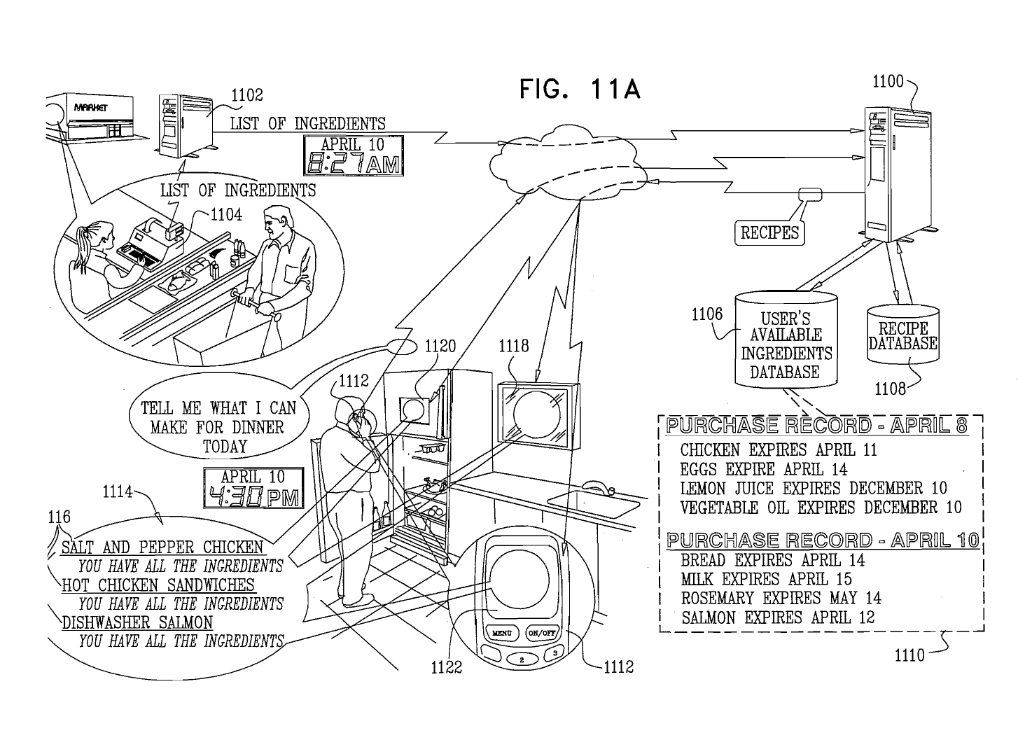

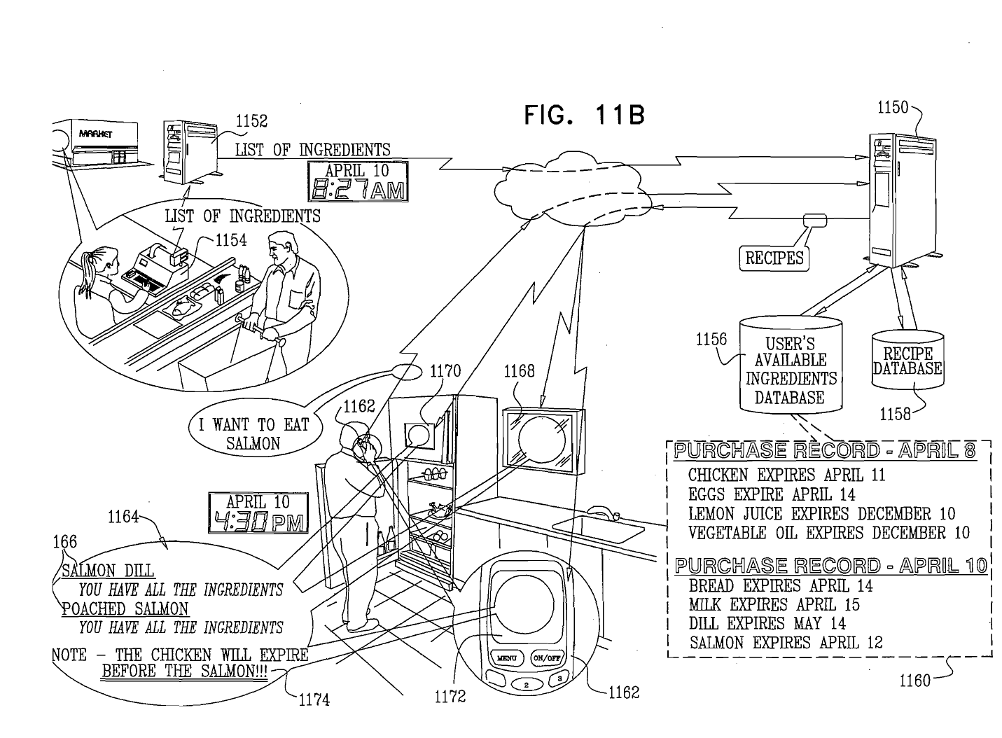

Reference is now made to FIGS. 11A and 11B, which are simplified pictorial illustrations of two alternative embodiments of a computerized methodology and system for integrated point of sale monitoring, ingredients inventorying, ingredient expiration monitoring and multi-media recipe presentation constructed and operative in accordance with a preferred embodiment of the present invention.

As seen in FIG. 11A, a user maintains a computerized inventory of user's available ingredients, typically by communicating with a recipe server 1100 via a point of sale server 1102 which is associated with a point of sale terminal 1104. The recipe server 1100 preferably has associated therewith a user's available ingredients database 1106 as well as a recipe database 1108. The communication is preferably by means of a communication network, which is typically a wireless communication network, such as the Internet. Here the user is shown at the point of sale in a super-market, where a cashier enters each ingredient bought by the user into the point of sale terminal 1104 in the morning, here shown as April 10 at 8:27 AM, for example. As seen, the list of ingredients entered into the point of sale terminal 1104 is communicated via the point of sale server 1102 to the recipe server 1100. The user's available ingredients database 1106 preferably maintains a cumulative record 1110 of all ingredients entered by the user, and of the expiration date of each of the ingredients. As seen, the record 1110 includes a listing of ingredients bought by the user on April 8, which includes chicken, eggs, lemon juice and vegetable oil, as well as a listing of ingredients bought by the user on April 10, which includes bread, milk, rosemary and salmon.

Later in the day or at some later date, here shown as April 10 at 4:30 PM, for example, the user inquires, preferably by voice and using a portable communicator, such as a web-enabled telephone 1112, or alternatively using any other suitable portable communicator functionality, “TELL ME WHAT I CAN MAKE FOR DINNER TODAY”. The user's request is processed by the recipe server 1100, which queries the user's available ingredients database 1106. In this example, the database 1106 indicates that the user has chicken, eggs, lemon juice, vegetable oil, bread, milk, rosemary and salmon, and the expiration dates of each of these ingredients. Based on the contents of database 1106, the recipe server 1100 queries the recipe database 1108 for recipes based on these ingredients and their expiration dates, and provides a list 1114 of links 1116 to a number of recipes. Preferably, all of the non-staple ingredients of the recipes indicated by links 1116 appear in database 1106. Preferably, links 1116 to recipes which use non-staple ingredients having imminent expiration dates will be higher on list 1114 than links to recipes including non-staple ingredients which are not about to expire. The links 1116 preferably appear on one or more displays, such as kitchen computer display 1118, a refrigerator door display 1120 and a display 1122 of mobile telephone 1112. Typical links include SALT AND PEPPER CHICKEN, HOT CHICKEN SANDWICHES and DISHWASHER SALMON.

The user may select one or more recipes by clicking on the appropriate link.

As seen in FIG. 11B, as in FIG. 11A, a user maintains a computerized inventory of user's available ingredients, typically by communicating with a recipe server 1150 via a point of sale server 1152 which is associated with a point of sale terminal 1154. The recipe server 1150 preferably has associated therewith a user's available ingredients database 1156 as well as a recipe database 1158. The communication is preferably by means of a communication network, which is typically a wireless communication network, such as the Internet. Here the user is shown at the point of sale in a super-market, where a cashier enters each ingredient bought by the user into the point of sale terminal 1154 in the morning, here shown as April 10 at 8:27 AM, for example. As seen, the list of ingredients entered into the point of sale terminal 1154 is communicated via the point of sale server 1152 to the recipe server 1150. The user's available ingredients database 1156 preferably maintains a cumulative record 1160 of all ingredients entered by the user, and of the expiration date of each of the ingredients. As seen, the record 1160 includes a listing of ingredients bought by the user on April 8, which includes chicken, eggs, lemon juice and vegetable oil, as well as a listing of ingredients bought by the user on April 10, which includes bread, milk, dill and salmon.

Later in the day or at some later date, here shown as April 10 at 4:30 PM, for example, the user states, preferably by voice and using a portable communicator, such as a web-enabled telephone 1162, or alternatively using any other suitable communicator functionality, “I WANT TO EAT SALMON”. The user's request is processed by the recipe server 1150, which queries the user's available ingredients database 1156. In this example, the database 1156 indicates that the user has chicken, eggs, lemon juice, vegetable oil, bread, milk, dill and salmon, and the expiration dates of these ingredients. Based on the contents of database 1156 and on the request of the user for a recipe including SALMON, the recipe server 1150 queries the recipe database 1158 for SALMON recipes based on these ingredients and provides a list 1164 including links 1166 to a number of recipes. Preferably, all of the non-staple ingredients of the recipes indicated by links 1166 appear in database 1156. The links 1166 preferably appear on one or more displays, such as kitchen computer display 1168, refrigerator door display 1170 and display 1172 of telephone 1162. Typical links include SALMON DILL and POACHED SALMON.

Preferably, if the user's requests a recipe including a main ingredient which is not the main ingredient with the most imminent expiration date, the server 1150 will alert the user that another main ingredient will expire sooner. In this example, following the links 1166 is a notice 1174 alerting the user to the fact that the chicken will expire before the salmon.

The user may select one or more recipes by clicking on the appropriate link.

It is appreciated that the functionality whereby a user updates the user's available ingredients database when ingredients are no longer available, as described hereinabove with reference to FIGS. 3C and 3F, may also be combined with the ingredients inventorying, ingredient expiration monitoring and multi-media recipe presentation functionality described hereinabove with reference to FIGS. 11A and 11B.

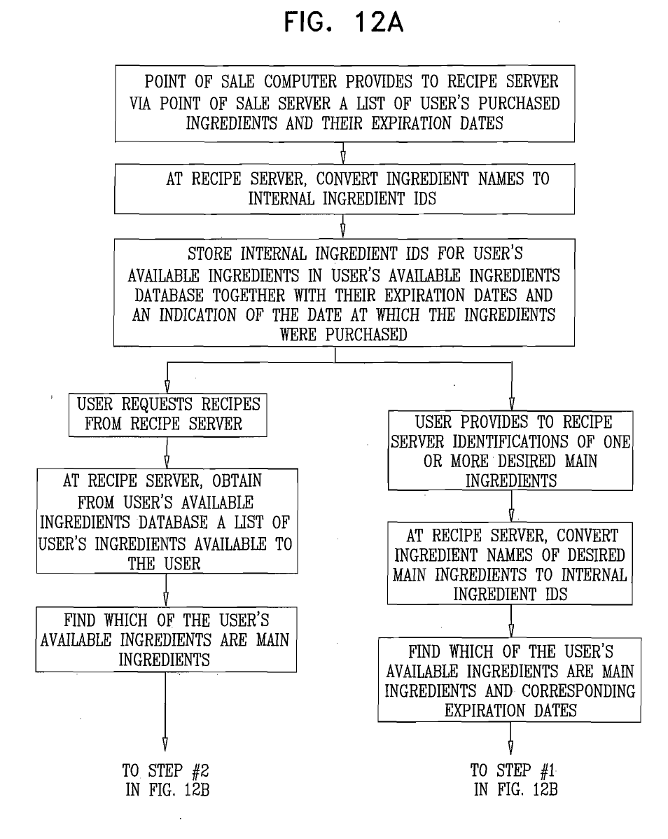

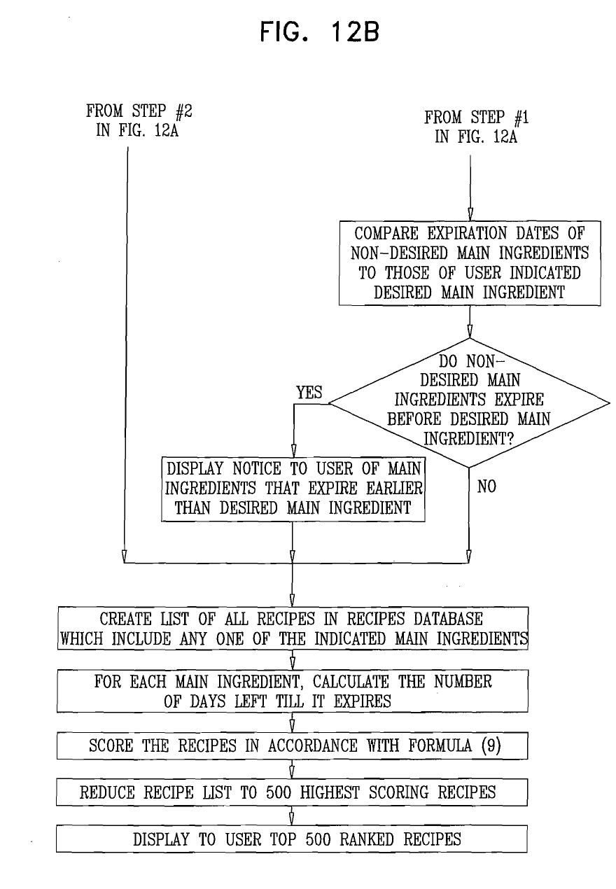

Reference is now made to FIGS. 12A and 12B, which together are a simplified flow chart illustrating the operation of the methodology and system of FIGS. 11A and 11B.

As seen in FIGS. 12A and 12B, a computerized inventory including indications of user purchased ingredients and associated expiration dates is provided from a point of sale terminal, such as point of sale terminal 1104 (FIG. 11A), to a recipe server, such as recipe server 1100 (FIG. 11A), via a point of sale server, such as point of sale server 1102 (FIG. 11A).

The recipe server is preferably operative to convert the received indications of the user's purchased ingredients to corresponding internal ingredient identification codes and to store these internal ingredients identification codes, and the corresponding expiration dates, as updates to a user's record in a user's available ingredients database, such as database 1106 (FIG. 11A). Preferably, the user's record includes, for each given ingredient listed therein, the date at which the user's record was updated to include the indication of the given ingredient.

At any later time, the user prompts the recipe server to provide recipes which the user could make from the user's available ingredients. In such a case, the recipe server is operative to process the user's request and obtains from the user's available ingredients database a list of the internal ingredient identification codes corresponding to the user's available ingredients. The recipe server is then operative to review the identification codes corresponding to the user's available ingredients and to find the identification codes which relate to main ingredients.

Alternatively, the user may provide to the recipe server an indication of one or more desired main ingredients which are available to the user. The recipe server is preferably operative to convert the received indications of the desired main ingredients to corresponding internal ingredient identification codes. The recipe server is operative to review the identification codes corresponding to the user's available ingredients and to find identification codes which relate to main ingredients, and the corresponding expiration dates. If the user's available ingredients list includes one or more main ingredient, which was not indicated by the user as a desired main ingredient, the expiration dates of these main ingredients are compared to the expiration dates of the desired main ingredients indicated by the user. If the expiration date of one or more of the non-desired main ingredients is closer than the expiration dates of the desired main ingredients, this main ingredient and its expiration date are noted by the server and the user is prompted to note that this main ingredient will be sooner to expire.

Once main ingredient identification codes are obtained by the recipe server, the recipe server is operative to obtain from a recipe database associated therewith, such as recipe database 1108 (FIG. 11A), a list of recipes which include any one or more of the main ingredients available to the user or which are desired by the user. The recipe server is additionally operative to obtain from the user's available ingredients database a list of all non-main ingredients which are available to the user, and to calculate the number of days remaining till the expiration date of each of the indicated main ingredients and of each of the non-main ingredients which are available to the user. The recipe server is then operative to rank the recipes in the recipes list as follows:

(1/(NUMBER OF DAYS REMAINING TILL EXPIRATION OF THE MAIN INGREDIENT IN THE RECIPE))*(NUMBER OF NON-MAIN INGREDIENTS IN THE LIST OF USER'S AVAILABLE INGREDIENTS WHICH ARE IN THE RECIPE*100)/TOTAL INGREDIENT COUNT FOR THE RECIPE (9)

The resulting ranked recipe list is preferably truncated after a predetermined number of highest ranked recipes, typically after the 500th highest ranked recipe, and may be displayed to the user, preferably as a list of links. The user may browse the list and select a desired recipe by clicking on it.

It is appreciated that if the user's available ingredients do not include any main ingredients, the recipe database provides the user with a list of recipes including one or more of the ingredients available to the user, in a similar manner to that described hereinabove with reference to the case in FIGS. 2A and 2B in which the user does not provide indications of non main ingredients.

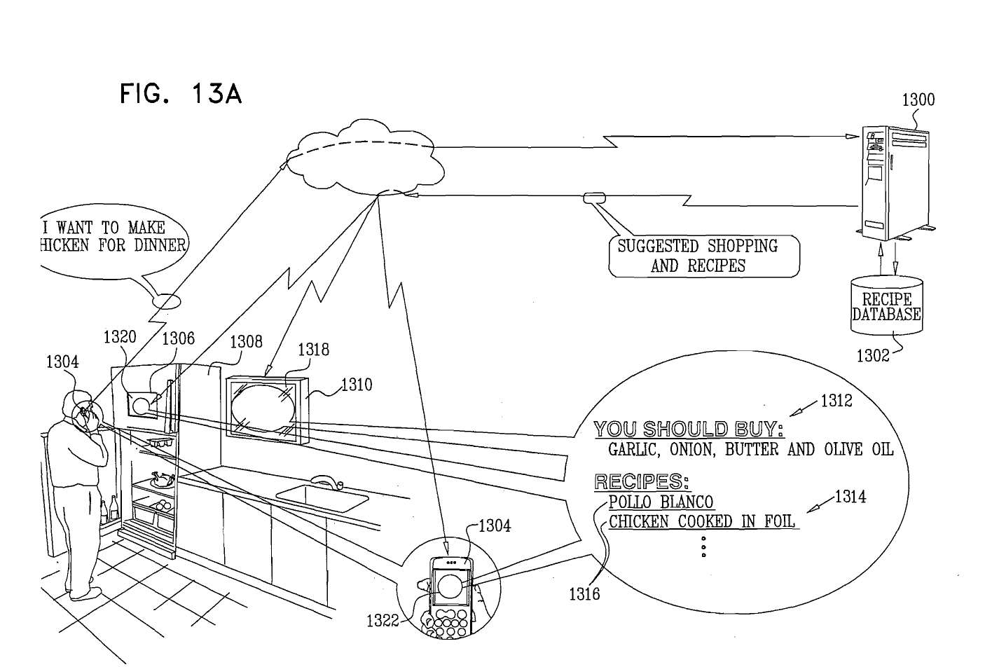

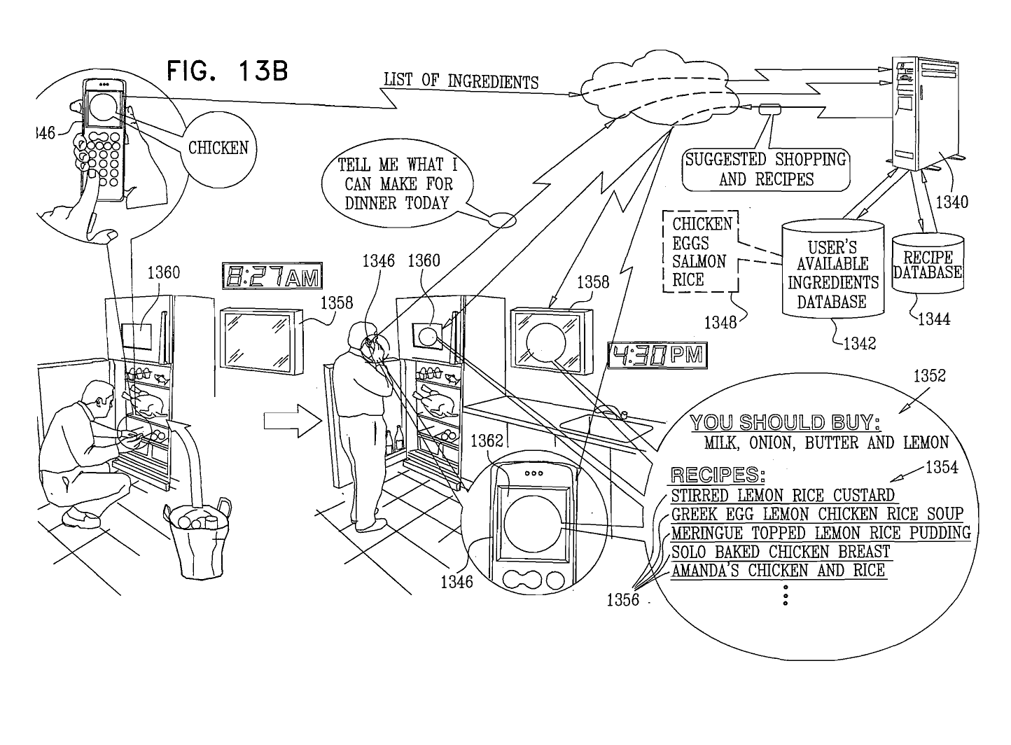

Reference is now made to FIGS. 13A and 13B, which are simplified pictorial illustrations of two alternative embodiments of a computerized methodology and system for integrated ingredients inventorying, ingredient purchase prompting and multi-media recipe presentation constructed and operative in accordance with a preferred embodiment of the present invention.

As seen in FIG. 13A, a user communicates via a communication network, which is typically a wireless communication network, such as the Internet with a recipe server 1300, having associated therewith a recipe database 1302. User communication with the recipe server 1300 may be in any suitable manner and may employ a web-enabled portable communication device, such as a Motorola Q cellular telephone 1304, a computer 1306 embedded into a kitchen appliance such as a refrigerator 1308 or a conventional fixed or portable computer 1310.

In a typical scenario, the user inputs to the recipe server 1300 an indication of one or more desired ingredients, which are preferably main ingredients, or indicates that he wishes to eat a specific food. In the illustrated example, the user says “I WANT TO MAKE CHICKEN FOR DINNER”.

The user's request is processed by the recipe server 1300, which queries the recipe database 1302 for CHICKEN recipes. The recipe server 1300 creates a list of all recipes in the recipe database 1302 which include any one or more of the desired main ingredients indicated by the user.

The recipe server 1300 ranks the list of recipes including chicken by the least number of additional non-staple ingredients required. The resulting ranked recipe list is preferably truncated after a predetermined number of highest ranked recipes, typically after the 500th highest ranked recipe.

Following truncating of the ranked recipe list, the recipe server 1300 finds additional ingredients which would be useful with the desired main ingredients. This is preferably carried out in the following manner. Each of the above highest ranked recipes is reviewed. Each non-user indicated, non-staple ingredient appearing in at least one of the highest ranked recipes is ranked by scoring each such ingredient as follows:

The score for each ingredient is the total of the individual scores for that ingredient, wherein an ingredient receives an individual score each time it appears in one of the highest ranked recipes.

Thus it is appreciated that non-main, non-staple ingredients which appear in recipes having few other ingredients are given substantially higher scores than non-main, non-staple ingredients which appear in recipes having a relatively large number of other ingredients.

The recipe server 1300 then provides to the user a suggested shopping list 1312 including the names of predetermined number of the top ranked non-main ingredients, typically four suggested ingredients. Typical suggested ingredients include GARLIC, ONION, BUTTER and OLIVE OIL. The recipe server 1300 further provides a list 1314 including links 1316 to a number of recipes which can be made with the indicated main ingredient and one or more of the suggested ingredients. The suggested shopping list 1312 and links 1316 preferably appear on one or more displays, such as a display 1318 of kitchen computer 1310, display 1320 of refrigerator computer 1306 and display 1322 of telephone 1304. Typical links include POLLO BLANCO and CHICKEN COOKED IN FOIL.

The user may select one or more recipes by clicking on the appropriate link.

Turning to FIG. 13B, it is seen that a user maintains a computerized inventory of user's available ingredients, typically by communicating with a recipe server 1340 having associated therewith a user's available ingredients database 1342 as well as a recipe database 1344. The communication is preferably by means of a cellular telephone network via a portable communicator, such as a web-enabled telephone 1346. Here the user is shown entering each ingredient via the telephone keypad upon returning from the supermarket in the morning, here shown as 8:27 AM, for example. It is appreciated that alternatively this may be done using any other suitable portable communicator functionality, such as voice communication. The user's available ingredients database 1342 preferably maintains a cumulative record 1348 of all ingredients entered by the user.

Later in the day or at some later date, here shown as 4:30 PM, for example, the user states, preferably by voice, or alternatively using any other suitable portable communicator functionality, “TELL ME WHAT I CAN MAKE FOR DINNER TODAY”. The user's request is processed by the recipe server 1340, which queries the user's available ingredients database 1342. In this example, the database 1342 indicates that the user has chicken, eggs, salmon and rice. Based on the contents of database 1342, the recipe server 1340 queries the recipe database 1344 for recipes based on these ingredients and creates a list of recipes, which typically include main ingredients which are available to the user.

The recipe server 1340 ranks the list of recipes according to the number of non-staple ingredients available to the user which are used in the recipe and the total number of ingredients required. The resulting ranked recipe list is preferably truncated after a predetermined number of highest ranked recipes, typically after the 500th highest ranked recipe.

Following truncating of the ranked recipe list, the recipe server 1340 finds additional ingredients which would be useful with the main ingredients available to the user. This is preferably carried out in the following manner. Each of the above highest ranked recipes is reviewed. Each non-user indicated, non-staple ingredient appearing in at least one of the highest ranked recipes is ranked by scoring each such ingredient as follows:

The score for each ingredient is the total of the individual scores for that ingredient, wherein an ingredient receives an individual score each time it appears in one of the highest ranked recipes.

Thus it is appreciated that non-main, non-staple ingredients which appear in recipes having few other ingredients are given substantially higher scores than non-main, non-staple ingredients which appear in recipes having a relatively large number of other ingredients.

The recipe server 1340 then provides to the user a suggested shopping list 1352 including the names of predetermined number of the top ranked non-main ingredients, typically four suggested ingredients. Typical suggested ingredients include MILK, ONION, BUTTER and LEMON. The recipe server 1340 further provides a list 1354 including links 1356 to a number of recipes which can be made using ingredients which are available to the user and one or more of the suggested ingredients. The suggested shopping list 1352 and links 1356 preferably appear on one or more displays, such as a kitchen computer display 1358, a refrigerator computer display 1360 and a display 1362 of mobile telephone 1346. Typical links include STIRRED LEMON RICE CUSTARD, GREEK EGG LEMON CHICKEN RICE SOUP, MERINGUE TOPPED LEMON RICE PUDDING, SOLO BAKED CHICKEN BREAST and AMANDA'S CHICKEN AND RICE.

The user may select one or more recipes by clicking on the appropriate link.

It is appreciated that the functionality whereby a user updates the user's available ingredients database when ingredients are no longer available, as described hereinabove with reference to FIGS. 3C and 3F, may also be combined with the ingredients inventorying, ingredient purchase prompting and multi-media recipe presentation functionality described hereinabove with reference to FIGS. 13A and 13B.

It is also appreciated that the computerized ingredients inventorying functionality whereby a user's available ingredients database is automatically updated by a point of sale server, associated with a point of sale terminal, communicating with a recipe server, as described hereinabove with reference to FIGS. 6A and 6B, may also be combined with the ingredients inventorying, ingredient expiration monitoring and multi-media recipe presentation functionality described hereinabove with reference to FIGS. 13A and 13B.

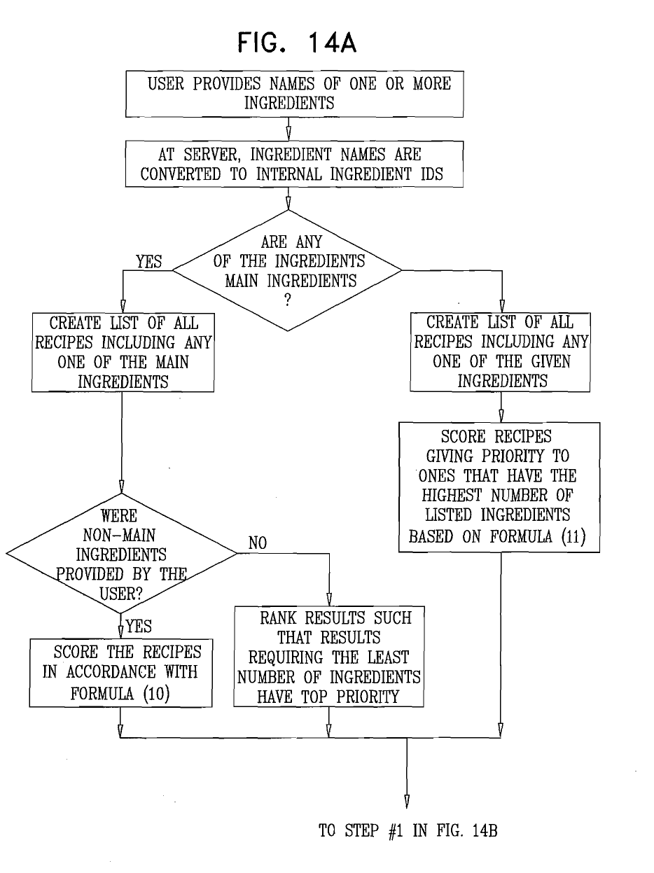

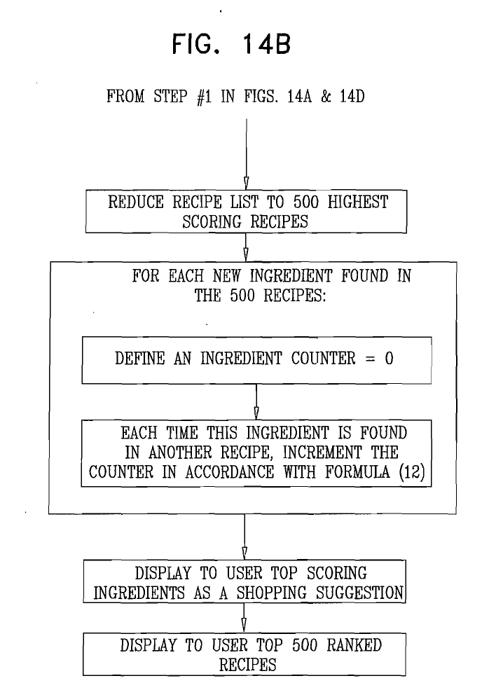

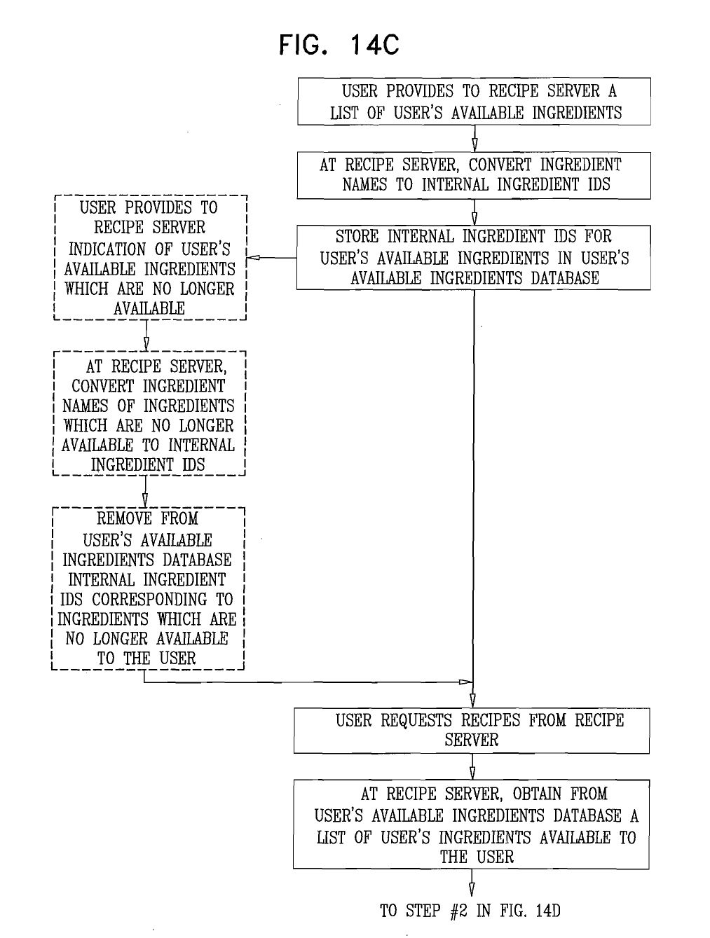

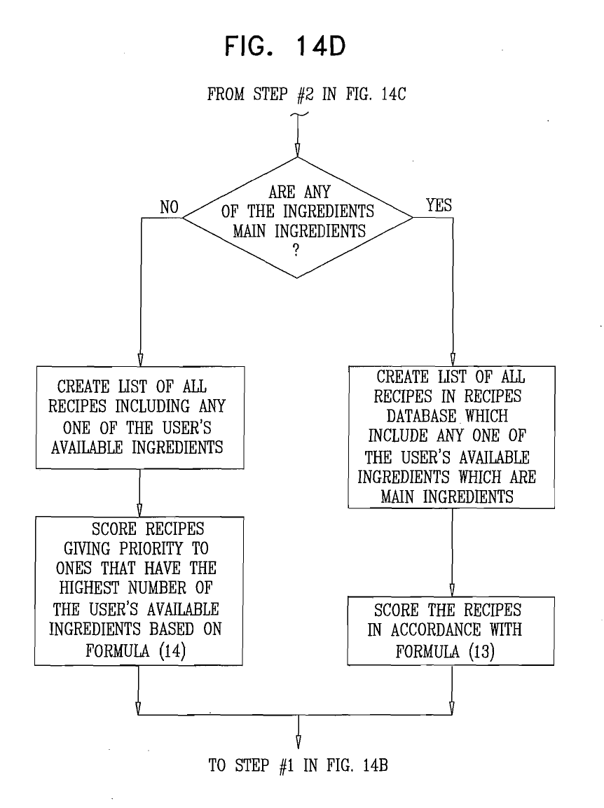

Reference is now made to FIGS. 14A, 14B, 14C and 14D, which together are a simplified flow chart illustrating the operation of the methodology and system of FIGS. 13A and 13B.

As seen in FIGS. 14A-14D, a user may operate the system in two alternative modes.

In accordance with a first mode of operation, as seen in FIG. 14A, the user provides to a recipe server, such as recipe server 1300 (FIG. 13A), an indication of one or more desired ingredients. The recipe server is preferably operative to convert the received indications of the user's available ingredients to corresponding internal ingredient identification codes. The recipe server is then operative to query a recipe database associated therewith, such as recipe database 1302 (FIG. 13A), for recipes including any one of the desired ingredients.

If any of the desired ingredients relate to main ingredients, the recipe server creates a list of all recipes in the recipe database which include any one or more of the main ingredients which are indicated by the user. If the desired ingredients indicated by the user do not include non-main ingredients, the recipe server ranks the list of recipes by the least number of additional non-staple ingredients required. If the user also indicated non-main ingredients, the recipe server ranks the recipes which contain the main ingredient as follows:

(NUMBER OF USER-INDICATED NON-MAIN INGREDIENTS IN RECIPE *100)/TOTAL INGREDIENT COUNT FOR THE RECIPE (10)

The resulting ranked recipe list is preferably truncated after a predetermined number of highest ranked recipes, typically after the 500th highest ranked recipe.

If none of the desired ingredients indicated by the user relate to main ingredients, the recipe server creates a list of all recipes in the recipe database which include any one or more of the ingredients which are indicated by the user. Generally, the recipes which contain one or more of the ingredients indicated by the user are ranked as follows:

(NUMBER OF USER-INDICATED INGREDIENTS IN RECIPE*100)/TOTAL INGREDIENT COUNT FOR THE RECIPE (11)

As seen in FIG. 14B, the resulting ranked recipe list is preferably truncated after a predetermined number of highest ranked recipes, typically after the 500th highest ranked recipe.

Following truncating of the ranked recipe list, the recipe server reviews each of the highest ranked recipes collected in the truncated recipe list. Each non-staple ingredient, which was not indicated by the user and/or which is not available to the user, and which appears in at least one of the highest ranked recipes, is ranked as follows:

The score for each ingredient is the total of the individual scores for that ingredient, wherein an ingredient receives an individual score each time it appears in one of the highest ranked recipes.

Each individual score is computed as follows:

(1/NUMBER OF NON-USER INDICATED OR USER AVAILABLE, NON-STAPLE INGREDIENTS IN THE RECIPE)² (12)

Thus it is appreciated that non-main, non-staple ingredients which appear in recipes having few other ingredients are given substantially higher scores than non-main, non-staple ingredients which appear in recipes having a relatively large number of other ingredients.

The recipe server then displays to the user a suggested shopping list including a predetermined number of the top ranked non-staple ingredients which were not indicated by the user and/or are not available to the user. Additionally, the recipe server displays to the user the list of highest ranked recipes, preferably as a list of links. The user may browse the list and select a desired recipe by clicking on it.

In accordance with a second mode of operation, as seen in FIGS. 14C and 14D, the user provides to a recipe server, such as recipe server 1340 (FIG. 13B), a computerized inventory including indications of the user's available ingredients. The recipe server is preferably operative to convert the received indications of the user's available ingredients to corresponding internal ingredient identification codes and to store these internal ingredients identification codes in a user's record in a user's available ingredients database, such as database 1342 (FIG. 13B).

At the same time or at any other time, the user may optionally provide to the recipe server an indication of user's available ingredients which are no longer available. The recipe server is preferably operative to convert the received indications of the no longer available ingredients to corresponding internal ingredient identification codes and to update the user's record in the user's available ingredients database to remove these internal ingredients identification codes from the user's record.

At any time, when the user requests recipes which can be made with the user's available ingredients, the recipe server processes the user's request and obtains from the user's available ingredients database a list of the internal ingredient identification codes corresponding to the user's available ingredients. The recipe server then reviews the identification codes corresponding to the user's available ingredients and finds the identification codes which relate to main ingredients. Subsequently, the recipe server creates a list of all recipes in a recipe database associated with the recipe server, such as recipe database 1344 (FIG. 13B), which include any one or more of the main ingredients which are available to the user.

The recipe server then notes the identification of the non-main ingredients in the user's available ingredients list, and ranks the recipes in the recipes list as follows:

(NUMBER OF NON-MAIN INGREDIENTS IN THE LIST OF USER'S AVAILABLE INGREDIENTS WHICH ARE IN THE RECIPE*100)/TOTAL INGREDIENT COUNT FOR THE RECIPE (13)

The resulting ranked recipe list is preferably truncated after a predetermined number of highest ranked recipes, typically after the 500th highest ranked recipe.

If the user's available ingredients do not include any main ingredients, the recipe server creates a list of all recipes in the recipe database which include any one or more of the user's available ingredients. Generally, the recipes which contain one or more of the user's available ingredients are ranked as follows:

(NUMBER OF USER'S AVAILABLE INGREDIENTS IN RECIPE *100)/TOTAL INGREDIENT COUNT FOR THE RECIPE (14)

The second mode of operation then continues, similarly to the first mode of operation as described hereinabove in reference to FIG. 14B.

It will be appreciated by persons skilled in the art that the present invention is not limited by what has been particularly shown and described hereinabove. Rather the scope of the present invention includes both combinations and sub-combinations of various features described and shown herein and modifications and variations thereof which are not known in the prior art.

1. A method for interactive recipe presentation comprising:
initially receiving, at a server, an indication from a user of at least one first ingredient;
querying said user, by said server, whether at least one additional ingredient is available;
additionally receiving, from said user in response to said querying, an indication of which, if any, of said at least one additional ingredient is available; and
providing to said user at least one recipe, which requires said at least one first ingredient and which requires any of said at least one additional ingredient which is available and which does not require other non-staple ingredients.

2. A method for interactive recipe presentation according to claim 1 and wherein at least one of said initially receiving and said additionally receiving employs communication via a computer network.

3. A method for interactive recipe presentation according to claim 1 and wherein at least one of said initially receiving and said additionally receiving employs communication via a cellular telephone network.

4. A method for interactive recipe presentation according to claim 1 and wherein at least one of said initially receiving and said additionally receiving employs voice communication.

5. A method for interactive recipe presentation according to claim 1 and wherein said querying comprises:
obtaining at least one recipe which requires said at least one first ingredient;
finding in said at least one recipe at least one other ingredient not included in said at least one first ingredient; and
querying said user whether said at least one other ingredient is available as said at least one additional ingredient.

6. A method for interactive recipe presentation comprising:
receiving, at a server, an indication from a user of at least one first ingredient;
automatically searching a database linked to said server to find recipes which require said at least one first ingredient;
ordering said recipes so as to give a first, higher, precedence to ones of said recipes which do not require non-staple ingredients other than said at least one first ingredient and to give successively lower precedence to ones of said recipes additionally requiring successively greater numbers of non-staple ingredients other than said at least one first ingredient; and
presenting said recipes to said user in accordance with said ordering.

7. A method for interactive recipe presentation according to claim 6 and wherein said receiving employs communication via a computer network.

8. A method for interactive recipe presentation according to claim 6 and wherein said receiving employs communication via a cellular telephone network.

9. A method for interactive recipe presentation according to claim 6 and wherein said receiving employs voice communication.

10. A method for interactive recipe presentation according to claim 6 and wherein said receiving comprises:
initially receiving, at said server, an indication from said user of said at least one first ingredient;
querying said user, by said server, whether at least one additional ingredient is available; and
additionally receiving, from said user in response to said querying, an indication of which, if any, of said at least one additional ingredient is available.

11. A method for interactive recipe presentation according to claim 10 and wherein said querying comprises:
obtaining at least one recipe which requires said at least one first ingredient;
finding in said at least one recipe at least one other ingredient not included in said at least one first ingredient; and
querying said user whether said at least one other ingredient is available as said at least one additional ingredient.

12. A method for interactive recipe presentation comprising:
receiving, at a server, from a user, a list of ingredients available to said user; and
providing to said user at least one recipe which requires at least one ingredient included in said list of ingredients and which does not require non-staple ingredients not included in said list of ingredients.

13. A method for interactive recipe presentation according to claim 12 and also comprising, prior to said providing,
receiving, at said server, an indication from said user of at least one first ingredient included in said list of ingredients and wherein said at least one recipe requires said at least one first ingredient.

14. A method for interactive recipe presentation according to claim 12 and wherein said receiving employs communication via a computer network.

15. A method for interactive recipe presentation according to claim 12 and wherein said receiving employs communication via a cellular telephone network.

16. A method for interactive recipe presentation according to claim 12 and wherein said receiving employs voice communication.

17. A method for interactive recipe presentation according to claim 12 and also comprising updating said list of ingredients to take into account at least one of additional available ingredients and ingredients no longer available.

18. A method for interactive recipe presentation according to claim 12 and wherein said receiving at a server, from a user, a list of ingredients available to said user includes automated reading of ingredient labels.

19. A method for interactive recipe presentation according to claim 18 and wherein said automated reading takes place at user premises.

20. A method for interactive recipe presentation according to claim 18 and wherein said automated reading takes place at a point of sale of said ingredients.

21. A method for interactive recipe presentation according to claim 18 and wherein said automated reading includes reading information indicating expiration dates of ones of said ingredients.

22. A method for interactive recipe presentation according to claim 21 and also comprising updating said list of ingredients to take into account at least one of additional available ingredients and ingredients no longer available based on said automated reading.

23. A method for interactive recipe presentation comprising:
receiving, at a server, from a user, a list of ingredients available to said user;
automatically searching a database linked to said server to find recipes which require at least one ingredient included in said list of ingredients;
ordering said recipes so as to give a first, higher, precedence to ones of said recipes which do not require non-staple ingredients not included in said list of ingredients and to give successively lower precedence to ones of said recipes additionally requiring successively greater numbers of non-staple ingredients not included in said list of ingredients; and
presenting said recipes to said user in accordance with said ordering.

24. A method for interactive recipe presentation according to claim 23 and also comprising, prior to said automatically searching, receiving at said server an indication from said user of at least one first ingredient and wherein said ordering gives higher precedence to ones of said recipes requiring said at least one first ingredient which do not require non-staple ingredients not included in said list of ingredients and successively lower precedence to ones of said recipes requiring said at least one first ingredient and additionally requiring successively greater numbers of non-staple ingredients not included in said list of ingredients.

25. A method for interactive recipe presentation according to claim 23 and also comprising updating said list of ingredients to take into account at least one of additional available ingredients and ingredients no longer available.

26. A method for interactive recipe presentation according to claim 23 and wherein said receiving employs communication via a computer network.

27. A method for interactive recipe presentation according to claim 23 and wherein said receiving employs communication via a cellular telephone network.

28. A method for interactive recipe presentation according to claim 23 and wherein said receiving employs voice communication.

29. A method for interactive recipe presentation according to claim 23 and wherein said receiving, at a server, from a user, a list of ingredients available to a user, includes automated reading of ingredient labels.

30. A method for interactive recipe presentation according to claim 29 and wherein said automated reading takes place at user premises.

31. A method for interactive recipe presentation according to claim 29 and wherein said automated reading takes place at a point of sale of said ingredients.

32. A method for interactive recipe presentation according to claim 29 and wherein said automated reading includes reading information indicating expiration dates of ones of said ingredients.

33. A method for interactive recipe presentation according to claim 32 and also comprising updating said list of ingredients to take into account at least one of additional available ingredients and ingredients no longer available based on said automated reading.

34. A method for interactive recipe presentation according to claim 32 and wherein said ordering said recipes gives higher precedence to ones of said recipes which require ones of said ingredients included in said list of ingredients whose expiration dates are imminent.

35. A method for interactive recipe presentation comprising:
receiving, at a server, from a point of sale, a list of ingredients purchased by a user; and
providing to said user at least one recipe which requires at least one ingredient included in said list of ingredients.

36. A method for interactive recipe presentation according to claim 35 and wherein said at least one recipe does not require non-staple ingredients not included in said list of ingredients.

37. A method for interactive recipe presentation according to claim 35 and wherein said providing includes printing said at least one recipe on a purchase receipt at said point of sale.

38. A method for interactive recipe presentation according to claim 35 and wherein said providing includes printing said at least one recipe at said point of sale.

39. A method for interactive recipe presentation according to claim 35 and wherein said providing includes providing said at least one recipe at user premises.

40. A method for interactive recipe presentation according to claim 35 and also including:
storing said list of ingredients in a user's available ingredients database associated with said server; and
additionally receiving, at said server, an indication from said user of at least one first ingredient included in said list of ingredients,
wherein said at least one recipe requires said at least one first ingredient.

41. A method for interactive recipe presentation according to claim 40 and wherein said additionally receiving employs communication via a computer network.

42. A method for interactive recipe presentation according to claim 40 and wherein said additionally receiving employs communication via a cellular telephone network.

43. A method for interactive recipe presentation according to claim 40 and wherein said additionally receiving employs voice communication.

44. A method for interactive recipe presentation according to claim 35 and also comprising updating said list of ingredients to take into account at least one of additional available ingredients and ingredients no longer available.

45. A method for interactive recipe presentation according to claim 35 and wherein said receiving from a point of sale includes automated reading of ingredient labels.

46. A method for interactive recipe presentation according to claim 45 and wherein said automated reading includes reading information indicating expiration dates of ones of said ingredients.

47. A method for interactive recipe presentation according to claim 46 and also comprising updating said list of ingredients to take into account at least one of additional available ingredients and ingredients no longer available based on said automated reading.

48. A method for interactive recipe presentation according to claim 35 and also comprising:
automatically searching a recipes database, by said server, to find recipes which require at least one ingredient included in said list of ingredients; and
ordering said recipes so as to give a first, higher precedence to ones of said recipes which do not require non-staple ingredients not included in said list of ingredients and to give successively lower precedence to ones of said recipes additionally requiring successively greater numbers of non-staple ingredients not included in said list of ingredients.

49. A method for interactive recipe presentation according to claim 48 and also comprising, prior to said searching, further receiving at said server an indication from said user of at least one first ingredient,
wherein said ordering gives higher precedence to ones of said recipes requiring said at least one first ingredient which do not require non-staple ingredients not included in said list of ingredients and successively lower precedence to ones of said recipes requiring said at least one first ingredient and additionally requiring successively greater numbers of non-staple ingredients not included in said list of ingredients.

50. A method for interactive recipe presentation according to claim 48 and also comprising updating said list of ingredients to take into account at least one of additional available ingredients and ingredients no longer available.

51. A method for interactive recipe presentation according to claim 49 and wherein said further receiving employs communication via a computer network.

52. A method for interactive recipe presentation according to claim 49 and wherein said further receiving employs communication via a cellular telephone network.

53. A method for interactive recipe presentation according to claim 49 and wherein said further receiving employs voice communication.

54. A method for interactive recipe presentation according to claim 48 and wherein said receiving includes automated reading of ingredient labels.

55. A method for interactive recipe presentation according to claim 54 and wherein said automated reading includes reading information indicating expiration dates of ones of said ingredients.

56. A method for interactive recipe presentation according to claim 55 and also comprising updating said list of ingredients to take into account at least one of additional available ingredients and ingredients no longer available based on said automated reading.

57. A method for interactive recipe presentation according to claim 55 and wherein said ordering said recipes gives higher precedence to ones of said recipes which requires ones of said ingredients included in said list of ingredients whose expiration dates are imminent.

58. A method for interactive presentation of shopping suggestions comprising:
receiving, at a server, an indication from a user of at least one first ingredient;
querying a recipe database for additional ingredients used together with said at least one first ingredient;
providing to said user an indication of said additional ingredients.

59. A method for interactive presentation of shopping suggestions according to claim 58 and wherein said receiving comprises receiving a list of ingredients available to said user.

60. A method for interactive presentation of shopping suggestions according to claim 59 and wherein said querying comprises querying said recipe database for additional ingredients often used together with subgroups of said list of ingredients.

61. A method for interactive presentation of shopping suggestions according to claim 59 and also comprising, prior to said providing, additionally receiving, at said server, an indication from said user of at least one principal ingredient included in said list of ingredients, and
wherein said providing comprises providing to said user an indication of at least one additional ingredient often used with said at least one principal ingredient.

62. A method for interactive presentation of shopping suggestions according to claim 59 and also comprising updating said list of ingredients to take into account at least one of additional available ingredients and ingredients no longer available.

63. A method for interactive presentation of shopping suggestions according to claim 59 and wherein said receiving said list of ingredients available to said user includes automated reading of ingredient labels.

64. A method for interactive presentation of shopping suggestions according to claim 63 and wherein said automated reading takes place at user premises.

65. A method for interactive presentation of shopping suggestions according to claim 63 and wherein said automated reading takes place at a point of sale of said ingredients.

66. A method for interactive presentation of shopping suggestions according to claim 63 and wherein said automated reading includes reading information indicating expiration dates of ones of said ingredients.

67. A method for interactive presentation of shopping suggestions according to claim 66 and also comprising updating said list of ingredients to take into account at least one of additional available ingredients and ingredients no longer available based on said automated reading.

68. A method for interactive presentation of shopping suggestions according to claim 58 and wherein said receiving comprises receiving an indication of a desired principal ingredient.

69. A method for interactive presentation of shopping suggestions according to claim 58 and also comprising presenting to said user at least one recipe requiring said at least one first ingredient and at least one of said additional ingredients.

70. A method for interactive presentation of shopping suggestions according to claim 58 and wherein said receiving employs communication via a computer network.

71. A method for interactive presentation of shopping suggestions according to claim 58 and wherein said receiving employs communication via a cellular telephone network.

72. A method for interactive presentation of shopping suggestions according to claim 58 and wherein said receiving employs voice communication.
